(19) United States
(12) Patent Application Publication
(10) Pub. No.: US 2024/0367049 A1
(43) Pub. Date: Nov. 7, 2024

(54) INFORMATION PROCESSING

(71) Applicant: Tencent Technology (Shenzhen) Company Limited, Shenzhen (CN)

(72) Inventors: Meng MENG, Shenzhen (CN); Jianyu HENG, Shenzhen (CN); Jieyi HUANG, Shenzhen (CN); Yuntao PENG, Shenzhen (CN); Yuanqin WANG, Shenzhen (CN); Zhenbin YE, Shenzhen (CN); Minwen DENG, Shenzhen (CN); Siqin LI, Shenzhen (CN); Wenjun WANG, Shenzhen (CN); Lin LIU, Shenzhen (CN); Lin LAI, Shenzhen (CN); Hongyang QIN, Shenzhen (CN)

(73) Assignee: Tencent Technology (Shenzhen) Company Limited, Shenzhen (CN)

(21) Appl. No.: 18/772,064

(22) Filed: Jul. 12, 2024

Related U.S. Application Data
(63) Continuation of application No. PCT/CN2023/089654, filed on Apr. 21, 2023.

(30) Foreign Application Priority Data
Jun. 23, 2022 (CN) 202210719475.0

(51) Int. Cl. A63F 13/56; A63F 13/52

(52) U.S. Cl. CPC A63F 13/56; A63F 13/52

(57) ABSTRACT

A method of information processing includes displaying a running screen of a target virtual game in a first time unit, the target virtual game includes at least a first virtual character that is manipulated by an artificial intelligence (AI) object. The method also includes obtaining battle reference data associated with the running screen, the battle reference data includes battle data fed back by the first virtual character when the first virtual character participates in the target virtual game in the first time unit. The method also includes displaying execution prediction information of at least a to-be-executed candidate operation based on the battle reference data. Apparatus and non-transitory computer-readable storage medium counterpart embodiments are also contemplated.

### RELATED APPLICATION

The present application is a continuation of International Application No. PCT/CN2023/089654, entitled “INFORMATION PROCESSING METHOD AND APPARATUS, AND STORAGE MEDIUM AND ELECTRONIC DEVICE” and filed on Apr. 21, 2023, which claims priority to Chinese Patent Application No. 202210719475.0, entitled “INFORMATION DISPLAY METHOD AND APPARATUS, STORAGE MEDIUM, AND ELECTRONIC DEVICE” filed on Jun. 23, 2022. The entire disclosures of the prior applications are hereby incorporated by reference.

### FIELD OF THE TECHNOLOGY

This application relates to the field of computers, including information processing technologies.

### BACKGROUND OF THE DISCLOSURE

With the rapid development of artificial intelligence, application of the artificial intelligence to a scene in a virtual game becomes a trend. In this trend, decision-making may be performed through the artificial intelligence in a running process of the virtual game. However, in the running process of the virtual game with the artificial intelligence, there is a problem that information is not displayed completely. Therefore, viewing experience in the virtual game and interpretability of the artificial intelligence are affected.

### SUMMARY

Embodiments of this disclosure provide an information processing method and apparatus, a storage medium, and an electronic device, to resolve at least a technical problem that information is not displayed completely.

According to an aspect of the embodiments of this disclosure, an information processing method is provided. The method is executed by an electronic device, and includes: displaying a running screen of a target virtual game in a first time unit, the target virtual game is a virtual game including at least a first virtual character that is manipulated by an artificial intelligence (AI) object. The method also includes obtaining battle reference data associated with the running screen, the battle reference data includes battle data fed back by the first virtual character when the first virtual character participates in the target virtual game in the first time unit. The method also includes displaying execution prediction information of at least a to-be-executed candidate operation based on the battle reference data, the to-be-executed candidate operation is a candidate operation to be executed by the first virtual character in a second time unit after the first time unit, the execution prediction information includes an auxiliary reference related to the battle reference data for a to-be-initiated manipulation instruction that is to be initiated by the AI object in the second time unit to cause the first virtual character to execute the to-be-executed candidate operation.

According to another aspect of the embodiments of this disclosure, an information processing apparatus is further provided. The apparatus is deployed on an electronic device, and includes processing circuitry configured to display a running screen of a target virtual game in a first time unit, the target virtual game is a virtual game including at least a first virtual character that is manipulated by an artificial intelligence (AI) object. The processing circuitry is further configured to obtain battle reference data associated with the running screen, the battle reference data includes battle data fed back by the first virtual character when the first virtual character participates in the target virtual game in the first time unit. The processing circuitry is further configured to display execution prediction information of at least a to-be-executed candidate operation based on the battle reference data, the to-be-executed candidate operation is a candidate operation to be executed by the first virtual character in a second time unit after the first time unit, the execution prediction information includes an auxiliary reference related to the battle reference data for a to-be-initiated manipulation instruction that is to be initiated by the simulation object in the second time unit to cause the first virtual character to execute the to-be-executed candidate operation.

According to still another aspect of the embodiments of this disclosure, a computer-readable storage medium is provided. The computer-readable storage medium includes a stored computer program, and the computer program, when being run by an electronic device, executes the information processing method.

According to still another aspect of the embodiments of this disclosure, a computer program product is provided. The computer program product includes a computer program, and the computer program is stored in a non-transitory computer-readable storage medium. A processor (also referred to as processing circuitry in some examples) of a computer device reads the computer program from the computer-readable storage medium, and the processor executes the computer program, to enable the computer device to execute the information processing method.

According to still another aspect of the embodiments of this disclosure, an electronic device is further provided. The electronic device includes a memory, a processor, and a computer program stored in the memory and run on the processor, and the processor executes the information processing method by using the computer program.

In the embodiments of this disclosure, in a running process of a target virtual game, a running screen corresponding to the target virtual game in a first time unit may be displayed. The first time unit may be a current time unit, the target virtual game is a virtual game in which at least one simulation object participates, and the simulation object is a virtual object driven by artificial intelligence and configured for simulating and manipulating a virtual character to participate in the target virtual game. The running screen is detected to obtain battle reference data corresponding to the running screen. The battle reference data is battle data fed back by the virtual character when the virtual character participates in the target virtual game in the first time unit. Then, execution prediction information corresponding to a to-be-executed candidate operation is displayed based on the battle reference data. The to-be-executed candidate operation is an operation to be executed by the virtual character in a second time unit, the execution prediction information is configured for providing an auxiliary reference related to the battle reference data to a to-be-initiated manipulation instruction, the to-be-initiated manipulation instruction is an instruction to be initiated by the simulation object in the second time unit and configured for manipulating the virtual character to execute the candidate operation, and the second time unit is after the first time unit. In other words, the execution prediction information may be used as a basis for determining a candidate operation to be executed. The execution prediction information is displayed to facilitate understanding, by a user, a reason for determining the corresponding candidate operation through the artificial intelligence, and help an audience quickly understand a decision-making idea of the artificial intelligence, to directly display a decision-making process of the virtual game with the artificial intelligence. Therefore, a technical effect of improving display completeness of information is achieved, and a technical problem that the information is not displayed completely is further resolved. Correspondingly, viewing experience in the virtual game and interpretability of the artificial intelligence are improved.

### BRIEF DESCRIPTION OF THE DRAWINGS

The accompanying drawings herein are used for providing a further understanding of this disclosure and constitute a part of this disclosure. Example embodiments of this disclosure and the descriptions thereof are intended to explain this disclosure, and do not constitute any limitation on this disclosure. In the accompanying drawings:

FIG. 1 is a schematic diagram of an application environment of an information processing method according to an embodiment of this disclosure.

FIG. 2 is a schematic flowchart of an information processing method according to an embodiment of this disclosure.

FIG. 3 is a schematic diagram of an information processing method according to an embodiment of this disclosure.

FIG. 4 is a schematic diagram of another information processing method according to an embodiment of this disclosure.

FIG. 5 is a schematic diagram of another information processing method according to an embodiment of this disclosure.

FIG. 6 is a schematic diagram of another information processing method according to an embodiment of this disclosure.

FIG. 7 is a schematic diagram of another information processing method according to an embodiment of this disclosure.

FIG. 8 is a schematic diagram of another information processing method according to an embodiment of this disclosure.

FIG. 9 is a schematic diagram of another information processing method according to an embodiment of this disclosure.

FIG. 10 is a schematic diagram of another information processing method according to an embodiment of this disclosure.

FIG. 11 is a schematic diagram of another information processing method according to an embodiment of this disclosure.

FIG. 12 is a schematic diagram of another information processing method according to an embodiment of this disclosure.

FIG. 13 is a schematic diagram of another information processing method according to an embodiment of this disclosure.

FIG. 14 is a schematic diagram of another information processing method according to an embodiment of this disclosure.

FIG. 15 is a schematic diagram of another information processing method according to an embodiment of this disclosure.

FIG. 16 is a schematic diagram of another information processing method according to an embodiment of this disclosure.

FIG. 17 is a schematic diagram of another information processing method according to an embodiment of this disclosure.

FIG. 18 is a schematic diagram of another information processing method according to an embodiment of this disclosure.

FIG. 19 is a schematic diagram of another information processing method according to an embodiment of this disclosure.

FIG. 20 is a schematic diagram of another information processing method according to an embodiment of this disclosure.

FIG. 21 is a schematic diagram of an information processing apparatus according to an embodiment of this disclosure.

FIG. 22 is a schematic diagram of a structure of an electronic device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

The specification, claims, and terms “first” and “second” of the foregoing accompanying drawings of this disclosure are used to distinguish similar objects, but are unnecessarily used to describe a specific sequence or order. The data used in such a way is interchangeable in proper circumstances, so that the embodiments of this disclosure described herein can be implemented in other sequences than the sequence illustrated or described herein. Moreover, the terms “comprise”, “include”, and any other variants thereof mean to cover the non-exclusive inclusion. For example, a process, method, system, product, or device that includes a list of operations or units is not necessarily limited to those operations or units that are listed, but may include other operations or units not expressly listed or inherent to such a process, method, system, product, or device.

In the embodiments of this disclosure, artificial intelligence (AI) is applied to a scene of a virtual game. In a running process of the virtual game, decision-making is performed through the artificial intelligence, to determine an operation that a simulation object manipulates a virtual character to execute in a next time unit.

The solutions provided in the embodiments of this disclosure relate to technologies such as computer vision and machine learning of the artificial intelligence. The solutions are described by using the following embodiments.

According to an aspect of the embodiments of this disclosure, an information processing method is provided. In an exemplary implementation, the information processing method may be applied to, but not limited to, an environment shown in FIG. 1. The information processing method may include, but is not limited to, a user device 102 and a server 112. The user device 102 may include, but is not limited to, a display 104, a processor 106, and a memory 108. The server 112 includes a database 114 and a processing engine 116.

A specific process may include the following operations.
S102: The user device 102 obtains a running screen 1002 corresponding to a target virtual game in a first time unit.
S104 to S106: Send screen data corresponding to the running screen 1002 (or battle viewing interface 1002) to the server 112 through a network 110.
S108 to S110: The server 112 obtains battle reference data corresponding to the running screen 1002 from the database 114. In addition, the server 112 obtains execution prediction information corresponding to a to-be-executed candidate operation through the processing engine 116 and based on the battle reference data.
S112 to S114: Send the execution prediction information to the user device 102 through the network 110. The user device 102 processes the execution prediction information on the display 104 through the processor 106, and stores the execution prediction information in the memory 108.

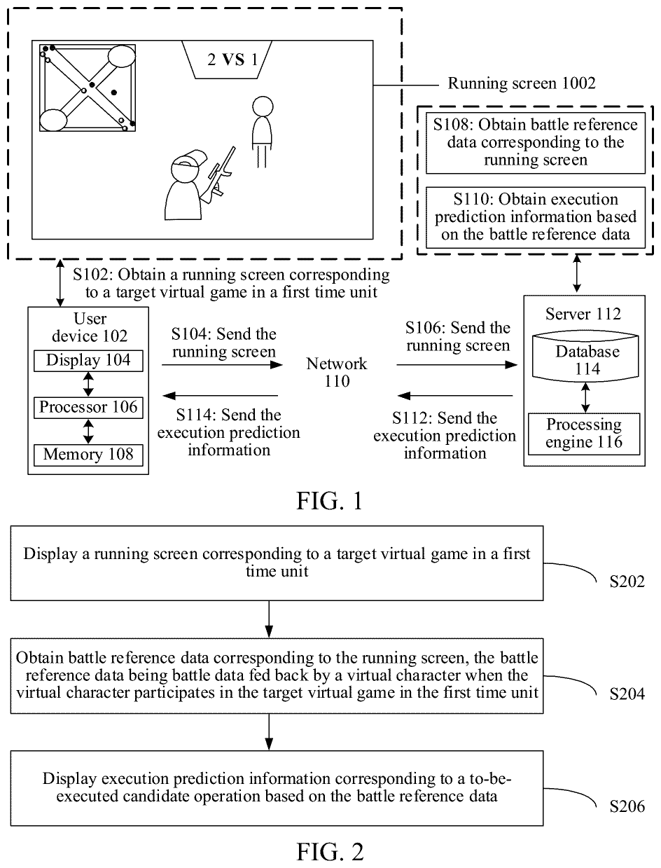

In addition to the example shown in FIG. 1, the foregoing operations may be performed with assistance of the server, to be specific, the server performs operations such as obtaining the battle reference data and obtaining the execution prediction information. Therefore, processing pressure of the server is reduced. The user device 102 includes, but is not limited to, a handheld device (for example, a mobile phone), a notebook computer, a desktop computer, a vehicle-mounted device, or the like. This disclosure does not limit a specific implementation of the user device 102. In an exemplary implementation, as shown in FIG. 2, an information processing method includes:
S202: Display a running screen corresponding to a target virtual game in a first time unit, the target virtual game being a virtual game in which at least one simulation object participates, and the simulation object being a virtual object driven by artificial intelligence and configured for simulating and manipulating a virtual character to participate in the target virtual game. The simulation object is also referred to as artificial intelligence (AI) object in some examples.
S204: Obtain battle reference data corresponding to the running screen, the battle reference data being battle data fed back by the virtual character when the virtual character participates in the target virtual game in the first time unit.
S206: Display execution prediction information corresponding to a to-be-executed candidate operation based on the battle reference data, the to-be-executed candidate operation being an operation to be executed by the virtual character in a second time unit, the execution prediction information being configured for providing an auxiliary reference related to the battle reference data to a to-be-initiated manipulation instruction, the to-be-initiated manipulation instruction being an instruction to be initiated by the simulation object in the second time unit and configured for manipulating the virtual character to execute the candidate operation, and the second time unit being after the first time unit.

In an exemplary implementation, in this embodiment, the information processing method may be applied to, but not limited to, a virtual game scene with the artificial intelligence, for example, a virtual game (target virtual game) of a battle between AI, or a virtual game (target virtual game) of a battle between AI and a real person. Further, the virtual game of the battle between AI and a real person is used as an example for description. In a human-machine battle process, in addition to displaying decision-making data of the AI in the battle, some key data that affects decision-making, such as a running process and a return of an AI based neural network, may be further displayed clearly. This can better help a user participating in the battle or a user viewing the battle to fully learn of a decision-making method of the AI.

In addition, the virtual game of the battle between AI is used as an example for description. Assuming that the virtual game is divided into two opposing teams, through AI of each team, a game task in the virtual game is autonomously executed by using technologies such as computer vision and machine learning, to compete for a final winner of the virtual game. Before initiating an operation instruction through the AI, the computer vision needs to be applied to collect information such as a game state in the virtual game, and the machine learning needs to be applied to determine an operation instruction to be executed. Therefore, decision-making process information is further displayed on a battle viewing interface in a simple manner. This helps the user viewing the battle fully understand the decision-making method of the AI with reference to a game battle screen. Therefore, ornamental value of the AI battle is improved, and the AI is interpretable.

In an exemplary implementation, in this embodiment, a time unit may be a time period in a preset duration range. The target virtual game may include, but is not limited to, at least one frame of the running screen in the time period. The preset duration range is not limited in this embodiment of this disclosure. The preset duration range may be, for example, 1 second, 1 minute, 1 hour, 5 seconds, 10 seconds, or 2 minutes, and may be set based on an actual requirement. A smaller preset duration range indicates a shorter time period indicated by the time unit, and the time period is closer to a moment. In the target virtual game, to perform information processing on each frame of the running screen in real time as much as possible by using the method provided in this embodiment of this disclosure, the time unit may be a time period including one frame of the running screen. Further assuming that the target virtual game includes one frame of the running screen in the time unit, the running screen corresponding to the first time unit may be understood as, but not limited to, a current frame of the running screen of the target virtual game, and the running screen corresponding to a second time unit may be understood as, but is not limited to, a next frame of the running screen of the target virtual game.

In an exemplary implementation, in this embodiment, the running screen may be understood as, but not limited to, a game screen in the virtual scene of the target virtual game. In addition, to improve efficiency of obtaining the battle reference data, all game screens in the virtual scene of the target virtual game may be obtained first; and then a part of game screens associated with the virtual character manipulated by the simulation object may be selected from all the game screens, and the part of game screens may be determined as the running screen. However, this is not limited thereto. In this way, efficient image recognition is performed on a selected game screen, to reduce duration of obtaining the battle reference data, and improve the efficiency of obtaining the battle reference data.

In an exemplary implementation, in this embodiment, a process of obtaining the battle reference data corresponding to the running screen may be, but is not limited to, applying the computer vision to perform recognition, collection, measurement, or another machine vision technology on the running screen, and performing further image processing, which may be, but is not limited to, technologies such as image processing, image recognition, image semantic understanding, image retrieval, optical character recognition (OCR), video processing, video semantic understanding, video content/behavior recognition, three-dimensional (3D) object reconstruction, 3D technology, virtual reality, augmented reality, synchronous positioning, and map construction.

In an exemplary implementation, in this embodiment, the simulation object is the virtual object driven by the artificial intelligence and configured for simulating and manipulating the virtual character to participate in the target virtual game, or may be understood as a virtual object that uses a digital computer or a machine controlled by the digital computer to simulate, spread, and expand intelligence of a human, perceive an environment, obtain knowledge, and use the knowledge to indicate the virtual character participating in the target virtual game to perform an optimal operation.

In an exemplary implementation, in this embodiment, the battle reference data is the battle data fed back by the virtual character when the virtual character participates in the target virtual game in the first time unit, such as game state data and game resource data. The game state data may be configured for indicating, but not limited to, an individual state of the virtual character participating in the target virtual game, and/or a local state of a plurality of virtual characters participating in the target virtual game, and/or an overall state of each team participating in the target virtual game. The game resource data may be configured for indicating, but not limited to, a held state, a non-held state, a distribution state, or the like of a virtual resource of the target virtual game, for example, a state of a virtual resource obtained by the virtual character (the held state of the virtual resource), a state of a virtual resource not obtained by the virtual character (the non-held state), or a distribution situation (the distribution state) of the virtual resource in the virtual scene of the target virtual game.

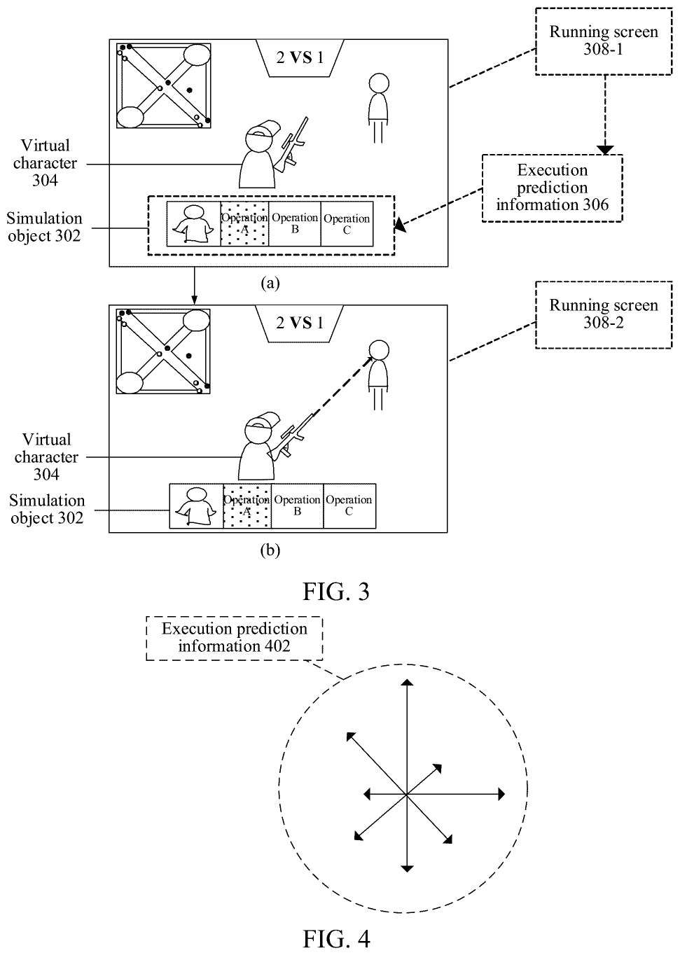

In an exemplary implementation, in this embodiment, the candidate operation to be executed by the virtual character in the second time unit may be understood as, but not limited to, a candidate operation that is not executed by the virtual character in a current time unit (the first time unit) but may be executed in a next time unit (the second time unit). As shown in (a) of FIG. 3, candidate operations that may be executed by a virtual character 304 manipulated by a simulation object 302 in the next time unit (the second time unit) include an operation A, an operation B, and an operation C. When execution prediction information 306 is obtained, the simulation object 302 determines an operation to be executed in the next time unit (the second time unit) from the operation A, the operation B, and the operation C. As shown in (b) of FIG. 3, the simulation object 302 determines the operation A, and initiates a manipulation instruction corresponding to the operation A, to instruct the virtual character 304 to execute the operation A. The execution prediction information 306 may be, but is not limited to, prediction information obtained based on battle reference data corresponding to a running screen 308-1. The running screen 308-1 may be, but is not limited to, a running screen corresponding to the target virtual game in the first time unit. A running screen 308-2 may be, but is not limited to, a running screen corresponding to the target virtual game in the second time unit.

In an exemplary implementation, in this embodiment, the manipulation instruction is an instruction initiated when the simulation object manipulates the virtual character to execute the candidate operation. The virtual character may participate in the target virtual game in, but not limited to, the following manner: The virtual character executes the target operation. That the virtual character executes the target operation may be, but is not limited to, responding to the manipulation instruction initiated by the simulation object. In other words, the simulation object may participate in the target virtual game in, but not limited to, the following manner: The simulation object initiates the manipulation instruction to manipulate the virtual character to execute the target operation.

In an exemplary implementation, in this embodiment, in a process of displaying the running screen corresponding to the target virtual game in the first time unit, more game information such as basic information (such as a name of the simulation object and a historical battle record of the simulation object) of at least one simulation object participating in the target virtual game, live process information (such as a virtual resource currently held by the virtual character, an item currently configured by the virtual character, and current battle information of the virtual character) of the target virtual game, and process prediction information (such as prediction information of a battle result of the target virtual game and prediction information of process development of the target virtual game) of the target virtual game may be displayed, but this is not limited thereto.

In an exemplary implementation, in this embodiment, a display method of the execution prediction information may be related to, but not limited to, information such as the candidate operation and the virtual character. For example, when the candidate operation is a movement operation, the execution prediction information may be displayed based on, but not limited to, a selected priority of each direction. As shown in FIG. 4, execution prediction information 402 includes each direction in which the movement operation can be executed, and the selected priority of each direction may be presented by, but not limited to, a length. For example, the length is positively related to the selected priority, to be specific, a longer direction indicates a higher selected priority of the direction, or a longest direction is a direction in which the movement operation is most likely to be executed.

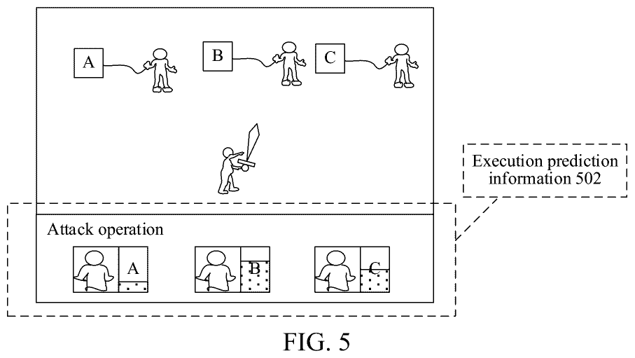

When the candidate operation is an attack operation, the execution prediction information may be displayed based on, but not limited to, a selected priority of each target object. As further shown in FIG. 5, execution prediction information 502 includes each target object that can be selected and on which the attack operation can be executed, and the selected priority of each target object may be presented by, but not limited to, a shade. For example, a display area of the shade is positively related to the selected priority, that is, a larger display area of the shade indicates a higher selected priority of the target object. For example, if a display area of a shade of a target object B is greater than a display area of a shade of a target object A and a display area of a shade of a target object C, the target object B has a highest selected priority, or a probability that the attack operation is executed on the target object B is the largest.

In a running process of the target virtual game, the running screen of the current time unit is detected to obtain the battle reference data of the current time unit. Then, a decision-making process in which the execution prediction information is calculated by using the battle reference data is displayed, so that the decision-making process in the virtual game with the artificial intelligence is directly displayed, and display completeness of information is improved.

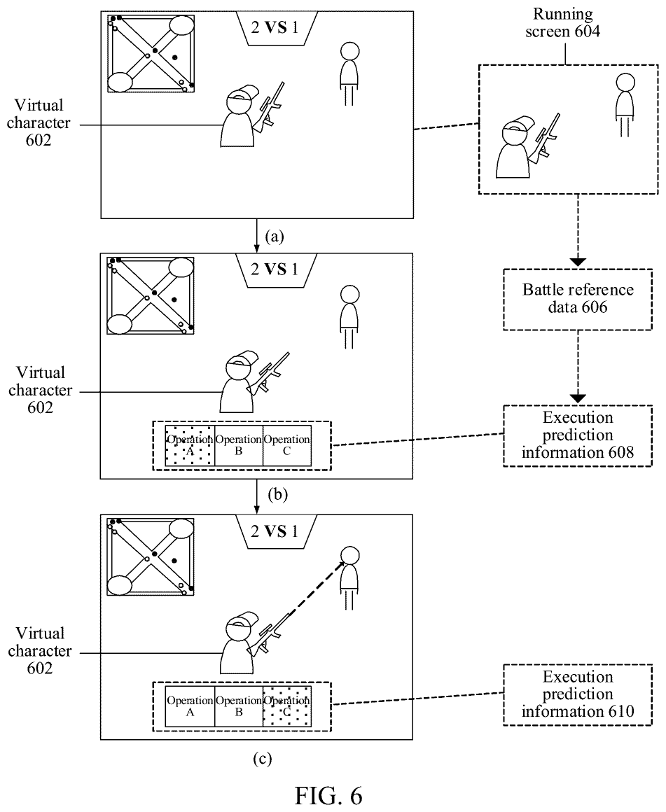

An example is further used for description. In an exemplary implementation, as shown in FIG. 6, a running screen 604 corresponding to a target virtual game in a first time unit is displayed. As shown in (a) of FIG. 6, the target virtual game is a virtual game in which at least one simulation object participates, and the simulation object is a virtual object driven by artificial intelligence and configured for simulating and manipulating a virtual character 602 to participate in the target virtual game.

As shown in (b) of FIG. 6, battle reference data 606 corresponding to the running screen 604 is obtained. The battle reference data 606 is battle data fed back by the virtual character 602 when the virtual character 602 participates in the target virtual game in the first time unit. Execution prediction information 608 corresponding to a candidate operation (for example, an operation A, an operation B, and an operation C) to be executed by the virtual character 602 in a second time unit is displayed based on the battle reference data 606. The execution prediction information 608 is configured for providing an auxiliary reference related to the battle reference data 606 to a manipulation instruction to be initiated by the simulation object in the second time unit, the manipulation instruction is an instruction initiated by the simulation object manipulating the virtual character 602 to execute the candidate operation, and the second time unit is after the first time unit.

In addition, the simulation object performs decision-making based on the execution prediction information 608, for example, initiates a manipulation instruction corresponding to the operation A in the second time unit, to manipulate the virtual character 602 to execute the operation A (attack an enemy character), as shown in (c) of FIG. 6. In addition, the running screen corresponding to the target virtual game in the second time unit may be reused to obtain latest battle reference data, and to obtain execution prediction information of a next time unit of the second time unit based on the latest battle reference data. However, this is not limited thereto. Principles are similar, and are not described in detail herein.

According to this embodiment provided in this disclosure, in a running process of a target virtual game, a running screen corresponding to the target virtual game in a first time unit may be displayed. The first time unit may be a current time unit, the target virtual game is a virtual game in which at least one simulation object participates, and the simulation object is a virtual object driven by artificial intelligence and configured for simulating and manipulating a virtual character to participate in the target virtual game. The running screen is detected to obtain battle reference data corresponding to the running screen. The battle reference data is battle data fed back by the virtual character when the virtual character participates in the target virtual game in the first time unit. Then, execution prediction information corresponding to a to-be-executed candidate operation is displayed based on the battle reference data. The to-be-executed candidate operation is an operation to be executed by the virtual character in a second time unit, the execution prediction information is configured for providing an auxiliary reference related to the battle reference data to a to-be-initiated manipulation instruction, the to-be-initiated manipulation instruction is an instruction to be initiated by the simulation object in the second time unit and configured for manipulating the virtual character to execute the candidate operation, and the second time unit is after the first time unit. In other words, the execution prediction information may be used as a basis for determining a candidate operation to be executed. The execution prediction information is displayed to facilitate understanding, by a user, a reason for determining the corresponding candidate operation through the artificial intelligence, and help an audience quickly understand a decision-making idea of the artificial intelligence, to directly display a decision-making process of the virtual game with the artificial intelligence. Therefore, a technical effect of improving display completeness of information is achieved, and a technical problem that the information is not displayed completely is further resolved. Correspondingly, viewing experience in the virtual game and interpretability of the artificial intelligence are improved.

In an exemplary implementation, the displaying execution prediction information corresponding to a to-be-executed candidate operation includes:
displaying first probability distribution information of at least two to-be-executed candidate operations, the first probability distribution information being configured for predicting a probability that the virtual character executes each of the at least two candidate operations in the second time unit.

In an exemplary implementation, in this embodiment, the first probability distribution information may be displayed in, but not limited to, a prediction information list. The prediction information list may be configured with, but not limited to, probability distribution information of various types of candidate operations associated with virtual characters.

In an exemplary implementation, in this embodiment, to improve display efficiency, when a quantity of to-be-displayed candidate operations is greater than a first quantity, the first quantity of candidate operations having larger probabilities are preferentially displayed. For example, when a probability of a candidate operation 1 is 70%, a probability of a candidate operation 2 is 50%, and a probability of a candidate operation 3 is 20%, the candidate operation 1 and the candidate operation 2 are preferentially displayed.

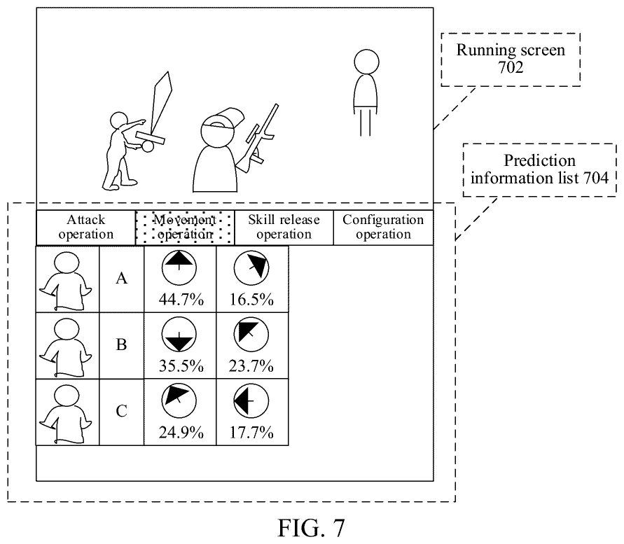

An example is further used for description. In an exemplary implementation, for example, as shown in FIG. 7, a running screen 702 and a prediction information list 704 corresponding to a target virtual game in a first time unit are displayed, and first probability distribution information of at least two candidate operations to be executed by a virtual character (for example, a virtual character A, a virtual character B, and a virtual character C) is displayed in the prediction information list 704. The first probability distribution information is configured for predicting a probability that the virtual character executes each of the at least two candidate operations in a second time unit. According to an exemplary aspect, probabilities of movement operations (for example, a movement operation in a first direction and a movement operation in a second direction) associated with the virtual character A, the virtual character B, and the virtual character C are displayed. The virtual character A is used as an example for description. A probability of the movement operation in the first direction is “44.7%”, a probability of the movement operation in the second direction is “16.5%”, and so on.

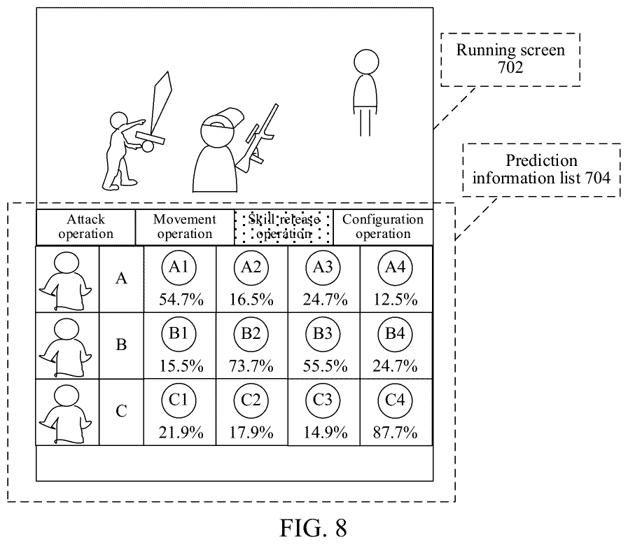

In addition, in this embodiment, based on the scene shown in FIG. 7, further as shown in FIG. 8, probabilities of skill release operations (for example, a release operation of a first skill and a release operation of a second skill) associated with the virtual character A, the virtual character B, and the virtual character C may be further displayed. The virtual character A is used as an example for description. A probability of a release operation of an A1 skill is “54.7%”, a probability of a release operation of an A2 skill is “16.5%”, a probability of a release operation of an A3 skill is “24.7%”, a probability of a release operation of an A4 skill is “12.57%”, and so on.

In addition, in this embodiment, a probability of an item configuration operation (for example, a configuration operation of an item 1 and a configuration operation of an item 2) associated with the virtual character may be further displayed. The item configuration operation may include, but is not limited to, replacing, dismounting, installing, purchasing, selling, storing into a first virtual container, removing from a second virtual container, and the like.

According to this embodiment provided in this disclosure, first probability distribution information of at least two to-be-executed candidate operations is displayed. The first probability distribution information being configured for predicting a probability that the virtual character executes each of the at least two candidate operations in the second time unit. In this way, the information is directly displayed based on probability distribution, and a technical effect that the information is more directly displayed is achieved.

In an exemplary implementation, the displaying execution prediction information corresponding to a to-be-executed candidate operation includes:
displaying second probability distribution information of the virtual character executing the candidate operation on at least two pointing objects, the second probability distribution information being configured for predicting a probability that the virtual character executes the candidate operation on each of the at least two pointing objects in the second time unit.

In an exemplary implementation, in this embodiment, the second probability distribution information may be displayed in, but not limited to, a prediction information list. The prediction information list may be configured with, but not limited to, probability distribution information of pointing objects associated with virtual characters.

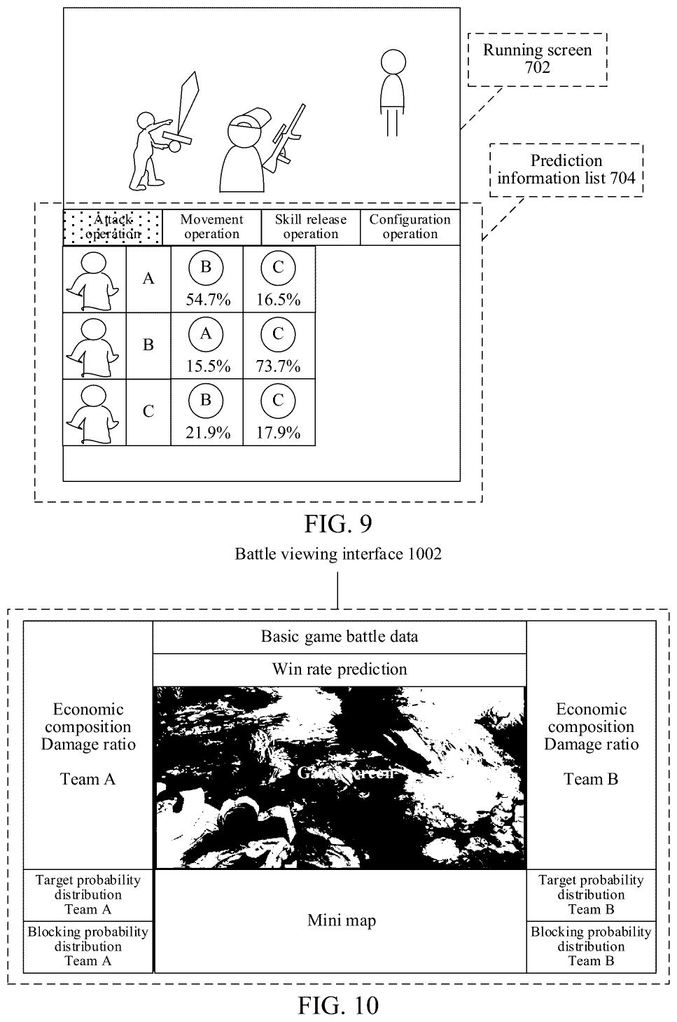

In an exemplary implementation, in this embodiment, to improve display efficiency, when a quantity of to-be-displayed candidate operations is greater than a second quantity, the second quantity of pointing objects having larger probabilities are preferentially displayed. For example, when a probability of a pointing object 1 is 70%, a probability of a pointing object 2 is 50%, and a probability of a pointing object 3 is 20%, the pointing object 1 and the pointing object 2 are preferentially displayed. An example is further used for description. In an exemplary implementation, based on the scene shown in FIG. 7, further as shown in FIG. 9, a running screen 702 and a prediction information list 704 corresponding to a target virtual game in a first time unit are displayed, and second probability distribution information of a virtual character (for example, a virtual character A, a virtual character B, and a virtual character C) executing a candidate operation on at least two pointing objects is displayed in the prediction information list 704. The second probability distribution information is configured for predicting a probability that the virtual character executes the candidate operation on each of the at least two pointing objects in a second time unit. According to an exemplary aspect, probabilities of pointing objects associated with the virtual character A, the virtual character B, and the virtual character C are displayed, for example, a pointing object B (the virtual character B) and a pointing object C (the virtual character C) associated with the virtual character A, a pointing object A (the virtual character A) and a pointing object C (the virtual character C) associated with the virtual character B, and the pointing object A (the virtual character A) and the pointing object B (the virtual character B) associated with the virtual character C. The virtual character A is used as an example for description. An execution probability of an attack operation on the pointing object B (the virtual character B) is “54.7%”, and an execution probability of an attack operation on the pointing object C (the virtual character C) is “16.5%”.

According to this embodiment provided in this disclosure, second probability distribution information of the virtual character executing the candidate operation on at least two pointing objects is displayed. The second probability distribution information is configured for predicting a probability that the virtual character executes the candidate operation on each of the at least two pointing objects in the second time unit. In this way, the information is directly displayed based on probability distribution, and a technical effect that the information is more directly displayed is achieved.

In an exemplary implementation, the displaying a running screen corresponding to a target virtual game in a first time unit includes: displaying the running screen in a first interface area in a battle viewing interface.

In an exemplary implementation, the displaying execution prediction information corresponding to a to-be-executed candidate operation includes: displaying the execution prediction information in a second interface area in the battle viewing interface.

The running screen is displayed in the first interface area in the battle viewing interface, and the execution prediction information is displayed in the second interface area in the battle viewing interface.

An example is further used for description. In an exemplary implementation, for example, as shown in FIG. 10, a running screen is displayed in a first interface area (a middle area of a battle viewing interface 1002) in the battle viewing interface 1002, and execution prediction information (for example, target probability distribution of a team A, blocking probability distribution of the team A, target probability distribution of a team B, and blocking probability distribution of the team B) is displayed in a second interface area in the battle viewing interface 1002. In addition, content such as basic game battle data, win rate prediction, economic composition of the team A, a damage ratio of the team A, economic composition of the team B, a damage ratio of the team B, and a mini map is further displayed on the battle viewing interface 1002.

According to this embodiment provided in this disclosure, the running screen is displayed in a first interface area in a battle viewing interface, and the execution prediction information is displayed in a second interface area in the battle viewing interface. In this way, more complete information is directly displayed on the battle viewing interface, and a technical effect of improving display completeness of the information is achieved.

In an exemplary implementation, the displaying the running screen in a first interface area in a battle viewing interface includes: displaying, in a first sub-area in the first interface area, a running main screen corresponding to the target virtual game in the first time unit, and displaying, in a second sub-area in the first interface area, a running sub-screen corresponding to the target virtual game in the first time unit, the running main screen being a real-time screen of the target virtual game in a virtual scene, and the running sub-screen being a thumbnail screen of the virtual scene.

In an exemplary implementation, the execution prediction information may further be displayed on the running sub-screen, and the displaying the execution prediction information in a second interface area in the battle viewing interface includes: displaying the execution prediction information in a third sub-area in the second interface area.

In an exemplary implementation, in this embodiment, the running screen and the execution prediction information may be displayed in, but not limited to, a same interface area or different interface areas, or the running screen is displayed in the first interface area in the battle viewing interface, and the execution prediction information is displayed in the second interface area in the battle viewing interface, but the running screen and the execution prediction information are intelligently displayed in, not limited to, different interface areas, and may be displayed in, but not limited to, the same interface area.

In an exemplary implementation, in this embodiment, in an AI battle, a real-time position of each virtual character may be displayed on, but not limited to, a mini map. On an avatar of each virtual character, a direction having a highest probability in blocking probability distribution of the virtual character is indicated by an arrow. In addition, simultaneous display of the first two directions having a highest probability may also be supported, but this is not limited thereto. This helps a user viewing the battle quickly understand decision-making information of the virtual character on the mini map (a running sub-screen), and better understand a decision-making idea of the AI. In addition, when first probability targets of two or more virtual characters are a same virtual character of an enemy, this event may be determined as, but not limited to, focus, and the event is displayed on the mini map, so that the user can directly understand intent of the AI.

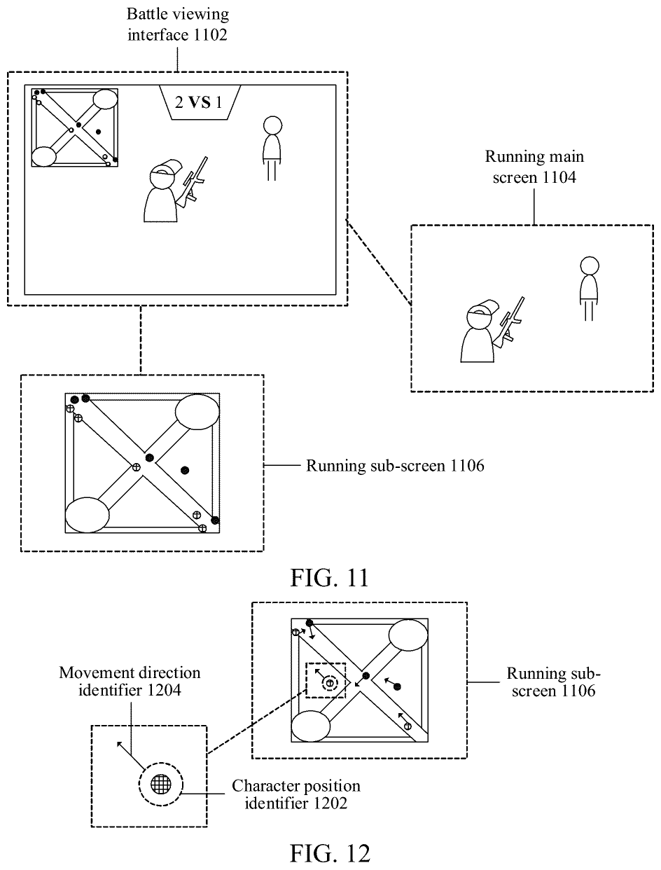

An example is further used for description. In an exemplary implementation, as shown in FIG. 11, a running main screen 1104 corresponding to a target virtual game in a first time unit is displayed on a battle viewing interface 1102, and a running sub-screen 1106 corresponding to the target virtual game in the first time unit is displayed on the battle viewing interface 1102. The running main screen 1104 is a real-time screen of the target virtual game in a virtual scene, the running sub-screen 1106 is a thumbnail screen of the virtual scene, and a character position identifier of a virtual character is displayed on the thumbnail screen. In addition, execution prediction information may further be displayed on, but not limited to, the running sub-screen 1106 and the battle viewing interface 1102.

According to this embodiment provided in this disclosure, a running main screen corresponding to the target virtual game in the first time unit is displayed in a first sub-area in a first interface area, and a running sub-screen corresponding to the target virtual game in the first time unit is displayed in a second sub-area in the first interface area. The running main screen is a real-time screen of the target virtual game in a virtual scene, and the running sub-screen is a thumbnail screen of the virtual scene. The execution prediction information is displayed on the running sub-screen, and the execution prediction information is displayed in a third sub-area of the second interface area. In this way, the information is efficiently displayed on the battle viewing interface, and a technical effect of improving display efficiency of the information is achieved.

In an exemplary implementation, when the character position identifier of the virtual character is displayed on the thumbnail screen, and the execution prediction information includes a movement direction identifier, the displaying the execution prediction information on the running sub-screen includes:
displaying the movement direction identifier at a position associated with the character position identifier on the running sub-screen, the movement direction identifier being configured for providing a direction reference to a movement instruction to be initiated by the simulation object in the second time unit, and the movement instruction being configured for instructing to manipulate the virtual character to move.

In an exemplary implementation, in this embodiment, the displaying the movement direction identifier at a position associated with the character position identifier may be understood as, but not limited to, displaying, with reference to the character position identifier, the execution prediction information in the second sub-area in which the running sub-screen is located.

An example is further used for description. In an exemplary implementation, based on FIG. 11, further as shown in FIG. 12, execution prediction information is displayed on a running sub-screen 1106, and, a movement direction identifier 1204 is displayed at a position associated with a character position identifier 1202. The movement direction identifier 1204 is configured for providing a direction reference to a movement instruction to be initiated by a simulation object in a second time unit, and the movement instruction is configured for instructing to manipulate a virtual character to move.

According to this embodiment provided in this disclosure, the movement direction identifier is displayed at the position associated with the character position identifier on the running sub-screen. In this way, the execution prediction information is more directly displayed by using brief information on the running sub-screen, and a technical effect that the information is more directly displayed is achieved.

In an exemplary implementation, a character position identifier of the virtual character is displayed on the thumbnail screen, the execution prediction information includes an operation trajectory identifier, and the displaying the execution prediction information on the running sub-screen includes:
highlighting, when a quantity of target candidate operations indicated by the operation trajectory identifier reaches a preset threshold, an operation trajectory identifier associated with the target candidate operation at a position associated with a target character position identifier on the running sub-screen, the operation trajectory identifier being configured for providing a pointing reference to a manipulation instruction to be initiated by the simulation object in the second time unit, the target candidate operation being a same candidate operation of a pointing object, and the target character position identifier being the character position identifier corresponding to the virtual character that is to initiate the target candidate operation in the second time unit.

In an exemplary implementation, in this embodiment, to improve display efficiency of the execution prediction information, when the quantity of target candidate operations indicated by the execution prediction information reaches the preset threshold, the operation trajectory identifier associated with the target candidate operation is highlighted at the position associated with the target character position identifier. For example, when the execution prediction information indicates that virtual characters whose quantity exceeds a value of the preset threshold execute an attack operation on a same virtual character, an operation trajectory identifier associated with the attack operation is highlighted at a position associated with a corresponding character position identifier.

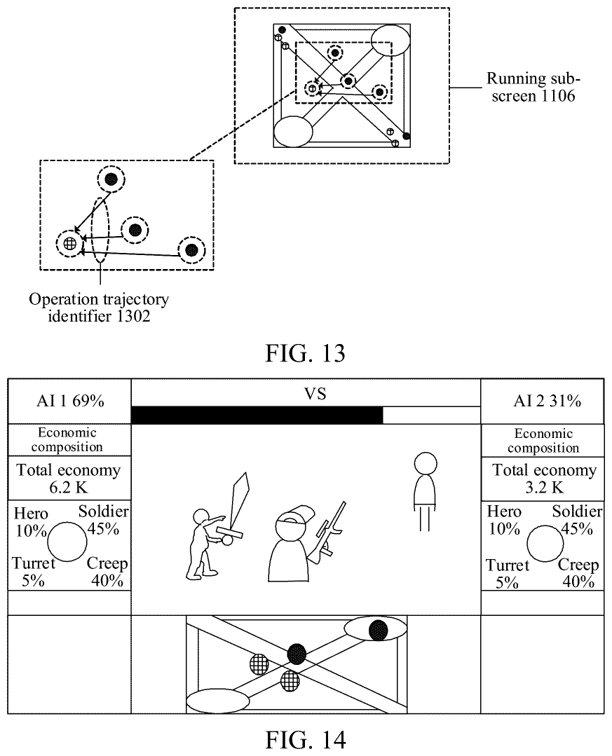

An example is further used for description. In an exemplary implementation, based on FIG. 11, further as shown in FIG. 13, when a quantity of target candidate operations indicated by execution prediction information reaches a preset threshold, execution prediction information (for example, an operation trajectory identifier associated with the target candidate operation) that meets a specific condition is highlighted on a running sub-screen 1106, and, an operation trajectory identifier 1302 associated with the target candidate operation is highlighted at a position associated with the target character position identifier. The operation trajectory identifier 1302 is configured for providing a pointing reference to a manipulation instruction to be initiated by a simulation object in a second time unit, the target candidate operation is a same candidate operation of a pointing object, and the target character position identifier is a character position identifier corresponding to a virtual character that is to initiate the target candidate operation in the second time unit.

According to this embodiment provided in this disclosure, when a quantity of target candidate operations indicated by an operation trajectory identifier reaches a preset threshold, an operation trajectory identifier associated with the target candidate operation is highlighted at a position associated with a target character position identifier, to highlight execution prediction information that meets a specific condition. In this way, a technical effect of improving display efficiency of the execution prediction information is achieved.

In an exemplary implementation, the displaying execution prediction information corresponding to a to-be-executed candidate operation includes at least one of the following:
S1: Display execution prediction information corresponding to a to-be-executed pointing operation if the to-be-executed candidate operation is the to-be-executed pointing operation, the execution prediction information corresponding to the to-be-executed pointing operation being configured for providing a pointing reference to a manipulation instruction to be initiated by the simulation object in the second time unit, and the pointing operation being configured for determining a pointing object of the manipulation instruction.
S2: Display execution prediction information corresponding to at least two to-be-executed candidate operations if the to-be-executed candidate operation is the at least two to-be-executed candidate operations, the execution prediction information corresponding to the at least two to-be-executed candidate operations being configured for providing a selection reference to at least two manipulation instructions to be initiated by the simulation object in the second time unit, and manipulation instructions of the at least two manipulation instructions corresponding one-to-one to candidate operations of the at least two candidate operations.
S3: Display execution prediction information corresponding to a to-be-executed movement operation if the to-be-executed candidate operation is the to-be-executed movement operation, the execution prediction information corresponding to the to-be-executed movement operation being configured for providing a direction reference to a movement instruction to be initiated by the simulation object in the second time unit.
S4: Display execution prediction information corresponding to a to-be-executed attack operation if the to-be-executed candidate operation is the to-be-executed attack operation, the execution prediction information corresponding to the to-be-executed attack operation being configured for providing a pointing reference to an attack instruction to be initiated by the simulation object in the second time unit.
S5: Display execution prediction information corresponding to a to-be-executed configuration operation if the to-be-executed candidate operation is the to-be-executed configuration operation, the execution prediction information corresponding to the to-be-executed configuration operation being configured for providing a pointing reference to a configuration instruction to be initiated by the simulation object in the second time unit, and the configuration operation being configured for determining a pointing item of the configuration instruction.

In an exemplary implementation, in this embodiment, in an AI battle, a list of targets to be attacked and a corresponding attack probability may be calculated by using battle data of a current frame of a game, and finally a target having a highest probability may be attacked through AI. However, this is not limited thereto. In addition, to make data direct and easy to understand, the first two targets having a highest probability in the list of targets may be displayed, but this is not limited thereto. At least two pointing objects are recorded in the list of targets.

In an exemplary implementation, in this embodiment, in an AI battle, a to-be-executed candidate operation and a corresponding execution probability may be calculated by using battle data of a current frame of a game, and finally a candidate operation having a highest probability may be executed through AI. However, this is not limited thereto. In addition, to make data direct and easy to understand, the first two candidate operations having a highest probability in candidate operations may be displayed, but this is not limited thereto. There are at least two to-be-executed candidate operations.

In an exemplary implementation, in this embodiment, in an AI battle, a movement direction and a corresponding probability may be calculated by using battle data of a current frame of a game, and finally movement to a direction having a highest probability may be implemented through AI. However, this is not limited thereto. In addition, to make data direct and easy to understand, the first two directions having a highest probability in a direction list may be displayed, but this is not limited thereto. There are at least two movement directions.

In an exemplary implementation, in this embodiment, in an AI battle, a to-be-configured virtual item and a corresponding probability may be calculated by using battle data of a current frame of a game, and finally a virtual item having a highest probability may be configured through AI. However, this is not limited thereto. In addition, to make data direct and easy to understand, the first two virtual items having a highest probability in virtual items may be displayed, but this is not limited thereto. There are at least two to-be-configured pointing items.

In an exemplary implementation, the displaying execution prediction information corresponding to a to-be-executed candidate operation includes:
S1: Display execution prediction information corresponding to a first virtual character when a screen perspective of the target virtual game is a character perspective of the first virtual character.
S2: Switch the screen perspective of the target virtual game to a character perspective of a second virtual character in response to a switching instruction of the screen perspective of the target virtual game, and display execution prediction information corresponding to the second virtual character.

In an exemplary implementation, in this embodiment, to improve display accuracy of the execution prediction information, a user viewing the battle may switch character perspectives of different virtual characters to adjust the screen perspective of the target virtual game, and may further correspondingly adjust display of the execution prediction information corresponding to the different virtual characters.

In an exemplary implementation, in a process in which the running screen corresponding to the target virtual game is displayed in the first time unit, the method further includes at least one of the following:
S1: Display battle basic information of at least one simulation object, the battle basic information being basic information of each of the at least one simulation object.
S2: Display battle instant information corresponding to the target virtual game in the first time unit, the battle instant information being instant information generated by the target virtual game when the target virtual game is run in the first time unit.
S3: Display battle historical information corresponding to the target virtual game in the first time unit, the battle historical information being historical information generated by the target virtual game before the target virtual game is run in the first time unit.
S4: Display battle prediction information corresponding to the target virtual game in the first time unit, the battle prediction information being prediction information of a battle result of the at least one simulation object participating in the target virtual game. An example is further used for description. In an exemplary implementation, display of an (event) battle viewing interface is used as an example for description. In an exemplary implementation, the battle viewing interface includes a game screen and a data module. After a game starts, a user viewing a battle may switch perspectives of different virtual characters by tapping an identifier corresponding to the virtual character.

In an exemplary implementation, in this embodiment, the data module may be understood as data displayed on the battle viewing interface with reference to FIG. 10, and includes, for example, basic game battle data, win rate prediction, economic composition, a damage ratio, target probability distribution, blocking probability distribution, and a mini map.

In an exemplary implementation, in this embodiment, the basic data may be displayed with reference to, but not limited to, data of a real person in the battle, and corresponding basic data is also extracted through AI to be displayed in the battle, including game data, team data, basic data of the virtual character, and the like.

In an exemplary implementation, in this embodiment, the game data may include, but is not limited to, a battle screen (battle instant information) and battle duration (battle historical information), and a plurality of AI battle conditions in the target virtual game may be displayed in real time through the battle screen, but this is not limited thereto.

In an exemplary implementation, in this embodiment, the team data may include, but is not limited to, a team name (battle basic information) of an AI model, kills/deaths/assists (KDA) (battle historical information), a quantity of defeated pharaohs (battle historical information), economic composition (battle historical information), and a proportion of virtual character damages (battle historical information). The economic composition and the proportion of virtual character damages are configured for helping the user viewing the battle understand operation thinking of an AI battle of both parties. This further presents different focuses of the user viewing the battle during AI training. The economic composition may be configured for displaying, but not limited to, a total economy of a team (not including a natural growth economy).

Based on this, further as shown in FIG. 14, a total economy may be further divided into a plurality of sources of defeating a virtual character, defeating a non-player character (NPC) (for example, a virtual soldier or a virtual creep), and an NPC building (for example, a virtual turret or a virtual crystal building), and a ratio of each of the plurality of sources to the total economy is displayed on a battle viewing interface.

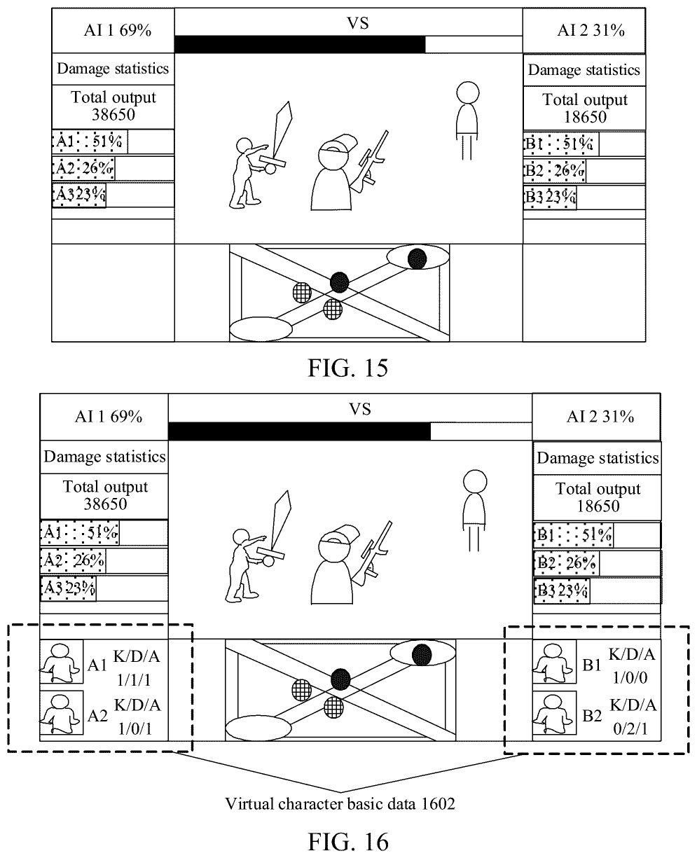

In addition, based on FIG. 14, as shown in FIG. 15, a proportion of virtual character damages is displayed. For example, a total damage caused to an enemy virtual character is displayed, and a proportion of damages caused by each virtual character to an enemy virtual character is displayed.

In an exemplary implementation, in this embodiment, the data module may further include, but is not limited to, basic data of a virtual character, for example, a virtual character avatar, a health point, a summoner spell, and a state. Further, based on the scene shown in FIG. 15, for example, as shown in FIG. 16, basic data 1602 of a virtual character is displayed, including a virtual character avatar, a virtual character name, KDA of the virtual character, and the like. In addition, after the virtual character avatar is tapped, a game screen may be correspondingly adjusted to a perspective of the virtual character, but this is not limited thereto.

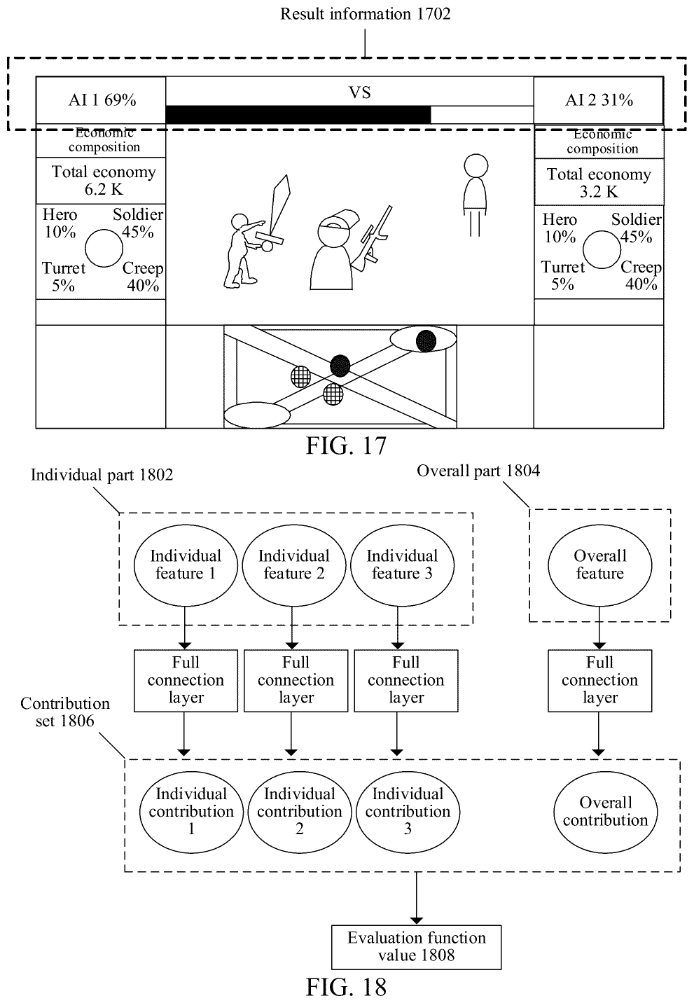

In an exemplary implementation, in this embodiment, the data module may further include, but is not limited to, win rate prediction (battle prediction information). For example, the win rate prediction is performed and displayed based on real-time battle data of both AI parties. Further, based on the scene shown in FIG. 14, for example, as shown in FIG. 17, win rate prediction is performed based on real-time battle data of both AI parties, and result information 1702 of the win rate prediction is displayed. For example, a win rate of AI 1 is 69%, and a win rate of AI 2 is 31%.

According to this embodiment provided in this disclosure, battle basic information of at least one simulation object is displayed, the battle basic information being the basic information of each of the at least one simulation object. Battle instant information corresponding to the target virtual game in the first time unit is displayed, the battle instant information being instant information generated by the target virtual game when the target virtual game is run in the first time unit. Battle historical information corresponding to the target virtual game in the first time unit is displayed, the battle historical information being historical information generated by the target virtual game before the target virtual game is run in the first time unit. Battle prediction information corresponding to the target virtual game in the first time unit is displayed, the battle prediction information being prediction information of a battle result of the at least one simulation object participating in the target virtual game. This archives an objective, and achieves a technical effect.

In an exemplary implementation, the displaying battle prediction information corresponding to the target virtual game in the first time unit is displayed includes:
S1: Obtain a battle screen of the target virtual game in a running process, the battle screen including the running screen.
S2: Obtain local battle state information and overall battle state information through the battle screen, the local battle state information being configured for indicating a battle state of each virtual character participating in the target virtual game in the target virtual game, and the overall battle state information being configured for indicating a (time unit based) battle state of the target virtual game in the first time unit.
S3: Obtain a first recognition result by using a battle prediction model and based on the local battle state information, and obtain a second recognition result by using the battle prediction model and based on the overall battle state information, the first recognition result being configured for indicating a contribution of each virtual character participating in the target virtual game to the battle result, and the second recognition result being configured for indicating a contribution of the battle state of the target virtual game in the first time unit to the battle result.
S4: Fit the first recognition result and the second recognition result, to obtain an evaluation function value, the evaluation function value being configured for evaluating a battle progress of the at least one simulation object in the target virtual game in terms of overall performance and local performance of an object.
S5: Obtain and display the battle prediction information based on the evaluation function value.

In an exemplary implementation, in this embodiment, a supervised learning model (battle prediction model) that uses a current game state (battle screen) as an input and the evaluation function value as an output may be used, to process the battle screen of the target virtual game in the running process, and to obtain the evaluation function value configured for obtaining the battle prediction information. However, this is not limited thereto.

In an exemplary implementation, in this embodiment, the battle prediction model may be, as shown in FIG. 18, divided into two sub-structures, but this is not limited thereto. According to an exemplary aspect, an individual (Ind) part is input as a state of each individual in the current state (for example, an individual feature 1, an individual feature 2, and an individual feature 3 in an individual part 1802), and is output as a contribution of each individual to a game situation (for example, an individual contribution 1, an individual contribution 2, and an individual contribution 3 in a contribution set 1806) by using a full connection layer for processing. A global (Glo) part is input as a global state in the current state (for example, an overall feature in an overall part 1804), and is output as a contribution of the global state to the game situation (for example, an overall contribution in the contribution set 1806) by using the full connection layer for processing. Finally, an evaluation function value 1808 is predicted by integrating outputs of the two sub-structures.

In an exemplary implementation, the obtaining and displaying the battle prediction information based on the evaluation function value includes:
S1: Determine, by using the evaluation function value if the target virtual game is a virtual game in which simulation objects of at least two opposing teams participate, predicted remaining duration for which each opposing team of the at least two opposing teams participate in the target virtual game.
S2: Obtain a predicted win rate of each opposing team for the target virtual game based on the predicted remaining duration, the predicted win rate being inversely proportional to the predicted remaining duration.
S3: Display the predicted win rate as the battle prediction information.

In an exemplary implementation, in this embodiment, the evaluation function value may be configured for, but not limited to, evaluating a relative advantage between game teams. Assuming that the target virtual game is a battle game between a team A and a team B, the evaluation function value may be configured for, but not limited to, reflecting an advantage of the team A relative to the team B, or an advantage of the team B relative to the team A. For details, refer to the following formula (1) and formula (2).

$$\\ \begin{matrix}DE ( R , t ) = \frac{1}{{ln ( 1 + r )}^{t}} \times R = \frac{R}{α t} where & ( 1 )\end{matrix}$$

$$\\ \begin{matrix}α = ln ( 1 + r ) , R = \{ \begin{matrix}1 , when Team A wins \\ - 1 , when Team B wins\end{matrix} & ( 2 )\end{matrix}$$

DE indicates a discount evaluation value, and an absolute value of DE is inversely proportional to remaining time of the game, that is, a greater advantage indicates a larger probability of winning. Therefore, the game is to end in shorter time. R indicates a bonus (which may be understood as a game result report, where for example, a win is recorded as 1, and a failure is recorded as −1). t indicates remaining duration of the game. r indicates an importance difference between a future bonus and a current bonus.

In an exemplary implementation, the obtaining battle reference data corresponding to the running screen includes: obtaining an image feature of the running screen based on the running screen and through a first network structure of an image recognition model, the battle reference data including the image feature, and the image recognition model being a neural network model trained by using sample data and configured for recognizing an image.

In an exemplary implementation, the running screen may be input to the first network structure of the image recognition model, and the first network structure is configured to extract the image feature. Therefore, the image feature of the running screen is obtained. To implement image feature extraction, the first network structure may include, but is not limited to, an input layer, a convolutional layer, a pooling layer, a full connection layer, and the like. The convolutional layer may include, but is not limited to, a plurality of convolutional units. A parameter of each convolutional unit is optimized by using a back-propagation algorithm. An objective of a convolutional operation is to extract different input features. A first convolutional layer may only extract some low-level features such as an edge, a line, and an angle. More layers of a network may iteratively extract more complex features from the low-level features. The pooling layer may be after the convolutional layer, but this is not limited thereto. The pooling layer also includes a plurality of feature surfaces. Each feature surface of the pooling layer corresponds to one feature surface of a layer above the pooling layer, and a quantity of feature surfaces is not changed. In the full connection layer, each node is connected to all nodes of a previous layer, and is configured for integrating the foregoing extracted features; but this is not limited thereto. Because of a full connection characteristic, generally, the full connection layer has most parameters.

In an exemplary implementation, the displaying execution prediction information corresponding to the to-be-executed candidate operation based on the battle reference data includes: obtaining a recognition result based on the image feature of the running screen and through a second network structure of the image recognition model, the execution prediction information including the recognition result.

In an exemplary implementation, the image feature of the running screen may be input to the second network structure of the image recognition model, and the second network structure is configured to classify based on the image feature extracted by the first network structure, to obtain the recognition result. The second network structure may include, but is not limited to, an output layer. An activation function used by the output layer may include, but is not limited to, a Sigmoid function, a tanh function, and the like. The activation function may include, but is not limited to, a basic structure of a single neuron and two parts of a linear unit and a non-linear unit.

In an exemplary implementation, the obtaining an image feature of the running screen based on the running screen and through a first network structure of an image recognition model includes:
S1: Perform performing image recognition on the running screen through a convolutional layer in the first network structure, to obtain at least two screen features corresponding to the running screen.
S2: Perform feature concatenation on the at least two screen features through a full connection layer in the first network structure, to obtain the image feature.

In an exemplary implementation, in this embodiment, a network performs feature coding on the image feature, a vector feature, and game state information through convolution, and then concatenates all feature codes by using the full connection (FC) layer to obtain a status code.

In an exemplary implementation, the obtaining a recognition result based on the image feature of the running screen and through a second network structure of the image recognition model includes:
S1: Map the image feature to an attention mechanism layer in the second network structure, to obtain a mapping result.
S2: Obtain the recognition result through an output layer in the second network structure and based on the mapping result.

In this embodiment of this disclosure, the second network structure includes the attention mechanism layer and the output layer, and the image feature may be mapped to the attention mechanism layer in the second network structure, to obtain the mapping result. The mapping result is input to the output layer in the second network structure, to obtain the recognition result.

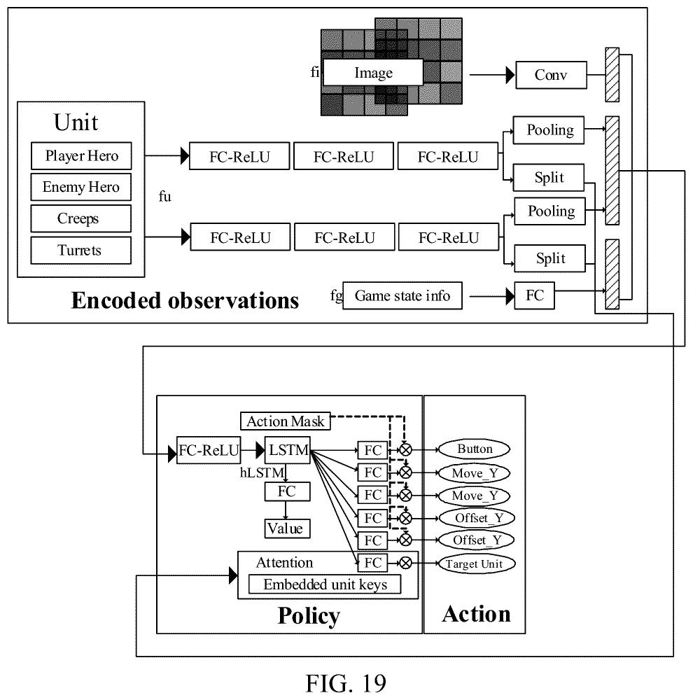

An example is further used for description. In an exemplary implementation, for example, as shown in FIG. 19, through deep reinforcement learning framework based training, an action control depending relationship in a target virtual game is modeled through an actor-critic network. First, the network performs feature coding on an image feature, a vector feature, and game state information through convolution, and then, uses a full connection (FC) layer to concatenate all feature codes to obtain a status code. Then, the status code is mapped to a heterogeneous long short-term memory (hLSTM) (an attention mechanism layer) by using a long short-term memory (LSTM) recurrent unit. The hLSTM is input to the FC layer to predict a final action output, including a movement operation, an attack operation, a skill release operation, a pointing object, and the like. In addition, to assist AI in making a more correct choice in a battle of the target virtual game, a target attention mechanism is introduced into a network structure design. The mechanism uses an FC output of the hLSTM as a query, and uses a stack encoded by all units as a key, to calculate target attention, that is, attention of the AI to each target in a current game state. Then, the attention of the AI to each target is visualized to more directly understand decision-making of the AI in the current state.

An actor-critic algorithm is an algorithm of deep reinforcement learning, and the algorithm defines two networks, that is, a policy network (Actor) and a critic network (Critic), to form the actor-critic network. The actor is mainly configured for training a policy to find an optimal action, and the critic is configured for scoring the action to find the best action. An LSTM is a long short-term memory network, and the hLSTM is a heterogeneous long short-term memory network.

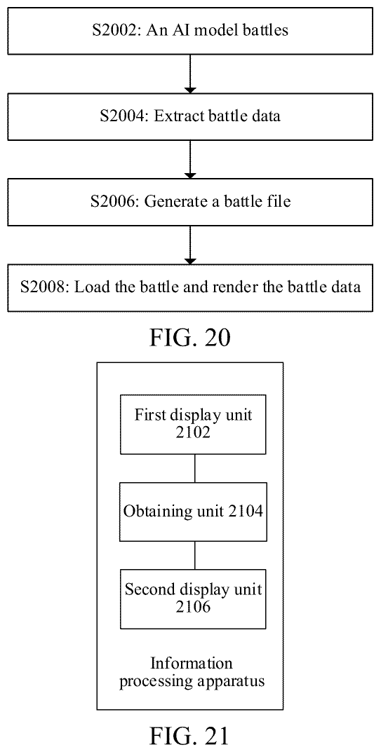

In an exemplary implementation, for ease of understanding, in this embodiment, it is assumed that the foregoing information processing method is applied to a battle scene of a multiplayer online battle arena (MOBA) game with AI. An overall procedure is shown in FIG. 20.
S2002: An AI model battles in a game environment.
S2004: Extract battle data during a battle.
S2006: Generate a corresponding battle file.
S2008: Load a battle screen through a front end, and render corresponding data in a corresponding module.

Data extraction in a real-time battle of the AI model includes extraction of data such as an economy and a damage of the AI battle. Visual display is performed, and win rate prediction is performed based on related data. Decision-making data (move and target) in the AI battle is extracted, structured, and clearly displayed to a user viewing the battle.

In an exemplary implementation, in this embodiment, the win rate prediction may assist the user viewing the battle to understand a game screen. Even if the user viewing the battle is unfamiliar with the game, the user may roughly guess a winning target of the game based on a win rate change. In addition, a win rate expectation that is dynamically changed may also increase dramatic tension of the game.

In an exemplary implementation, in this embodiment, in a game having a score mechanism, usually, a player or a team that has an advantage may be easily determined based on scores. However, a design of the MOBA game is very complex, and many variables change throughout the game. Therefore, in such a large knowledge domain, it is very difficult to evaluate a real-time game situation. Conventionally, in the related art, a relative advantage is evaluated based on intuition or a fuzzy method such as game experience, but a uniform standard cannot be provided to measure a relative advantage between game teams.

In an exemplary implementation, in this embodiment, in the MOBA game, a current state indicates a game situation of a specific time slice, including an individual state and a global state. The individual state includes a level, an economy, a survival state, and the like of a team virtual character, and the global state includes a soldier line, a turret state, and the like. The information for indicating the current game state may all be found from a game record, for example, a playback file.

In an exemplary implementation, in this embodiment, content of the data is not limited to the basic data, the target probability distribution, the blocking probability distribution, and the mini map, but data display in more dimensions may be added based on a game type, and a content display method of the data is a form of visualization, for example, a line chart or a heat map. A terminal device for display is not limited to a PC end, and may be a mobile device, a large screen device, or the like. Operation and interaction may be performed through, but not limited to a mouse and a keyboard, and may be performed through a gesture, voice control, or the like.

According to embodiments provided in this disclosure, an AI game battle is a battle of a reinforcement learning model. Different from a real life game battle, a training idea and algorithm optimization of an AI model are more focused, and human factors such as an emotion, a mood, and a reaction are not included. In this disclosure, a decision-making process and data of the AI model are displayed, and are displayed in real time with reference to a battle screen to a user viewing the battle, to innovatively provide a unique real-time display method of an AI battle in a MOBA game, so that AI is interpretable, and ornamental value of the AI game battle is effectively improved.

In the specific embodiments of this disclosure, when the embodiments of this disclosure are applied to a specific product or technology, separate user permission or consent need to be obtained for data related to user information, such as collection, use, and processing of the related data need to comply with the laws, regulations, and standards of related countries and regions.

For the foregoing method embodiments, for brief description, all method embodiments are described as a series of action combinations. However, it is noted that the present disclosure is not limited by the described action sequence. Because in accordance with this disclosure, operations may be performed in other orders or simultaneously. In addition, it is noted that embodiments described in the specification are some examples, and the involved action and module are not necessarily required for this disclosure.

According to another aspect of the embodiments of this disclosure, an information processing apparatus configured to implement the foregoing information processing method is further provided. As shown in FIG. 21, the apparatus includes:
a first display unit 2102, configured to display a running screen corresponding to a target virtual game in a first time unit, the target virtual game being a virtual game in which at least one simulation object participates, and the simulation object being a virtual object driven by artificial intelligence and configured for simulating and manipulating a virtual character to participate in the target virtual game;
an obtaining unit 2104, configured to obtain battle reference data corresponding to the running screen, the battle reference data being battle data fed back by the virtual character when the virtual character participates in the target virtual game in the first time unit; and
a second display unit 2106, configured to display execution prediction information corresponding to a to-be-executed candidate operation based on the battle reference data, the to-be-executed candidate operation being an operation to be executed by the virtual character in a second time unit, the execution prediction information being configured for providing an auxiliary reference related to the battle reference data to a to-be-initiated manipulation instruction, the to-be-initiated manipulation instruction being an instruction to be initiated by the simulation object in the second time unit and configured for manipulating the virtual character to execute the candidate operation, and the second time unit being after the first time unit.

For a specific embodiment, refer to the examples shown in the foregoing information processing method. Details are not described again in this example.

According to this embodiment provided in this disclosure, in a running process of a target virtual game, a running screen corresponding to the target virtual game in a first time unit may be displayed. The first time unit may be a current time unit, the target virtual game is a virtual game in which at least one simulation object participates, and the simulation object is a virtual object driven by artificial intelligence and configured for simulating and manipulating a virtual character to participate in the target virtual game. The running screen is detected to obtain battle reference data corresponding to the running screen. The battle reference data is battle data fed back by the virtual character when the virtual character participates in the target virtual game in the first time unit. Then, execution prediction information corresponding to a to-be-executed candidate operation is displayed based on the battle reference data. The to-be-executed candidate operation is an operation to be executed by the virtual character in a second time unit, the execution prediction information is configured for providing an auxiliary reference related to the battle reference data to a to-be-initiated manipulation instruction, the to-be-initiated manipulation instruction is an instruction to be initiated by the simulation object in the second time unit and configured for manipulating the virtual character to execute the candidate operation, and the second time unit is after the first time unit. In other words, the execution prediction information may be used as a basis for determining a candidate operation to be executed. The execution prediction information is displayed to facilitate understanding, by a user, a reason for determining the corresponding candidate operation through the artificial intelligence, and help an audience quickly understand a decision-making idea of the artificial intelligence, to directly display a decision-making process of the virtual game with the artificial intelligence. Therefore, a technical effect of improving display completeness of information is achieved, and a technical problem that the information is not displayed completely is further resolved. Correspondingly, viewing experience in the virtual game and interpretability of the artificial intelligence are improved.

In an exemplary implementation, the second display unit 2106 includes
a first display module, configured to display first probability distribution information of at least two to-be-executed candidate operations, the first probability distribution information being configured for predicting a probability that the virtual character executes each of the at least two candidate operations in the second time unit.

For a specific embodiment, refer to the examples shown in the foregoing information processing method. Details are not described again in this example.

In an exemplary implementation, the second display unit 2106 includes
a second display module, configured to display second probability distribution information of the virtual character executing the candidate operation on at least two pointing objects, the second probability distribution information being configured for predicting a probability that the virtual character executes the candidate operation on each of the at least two pointing objects in the second time unit.

For a specific embodiment, refer to the examples shown in the foregoing information processing method. Details are not described again in this example.

In an exemplary implementation, the first display unit 2102 includes a third display module, configured to display the running screen in a first interface area in a battle viewing interface.

The second display unit 2106 includes a fourth display module, configured to display the execution prediction information in a second interface area in the battle viewing interface.

For a specific embodiment, refer to the examples shown in the foregoing information processing method. Details are not described again in this example.

In an exemplary implementation, a third display module includes a first display sub-module, configured to: display, in a first sub-area in the first interface area, the running main screen corresponding to the target virtual game in the first time unit, and display, in a second sub-area in the first interface area, the running sub-screen corresponding to the target virtual game in the first time unit, the running main screen being a real-time screen of the target virtual game in a virtual scene, and the running sub-screen being a thumbnail screen of the virtual scene.

A fourth display module includes a second display sub-module, configured to display the execution prediction information in a third sub-area in the second interface area.

The second display sub-module is further configured to display the execution prediction information on the running sub-screen.

For a specific embodiment, refer to the examples shown in the foregoing information processing method. Details are not described again in this example.

In an exemplary implementation, a character position identifier of the virtual character is displayed on the thumbnail screen, the execution prediction information includes a movement direction identifier, and the second display submodule includes
a first display sub-unit, configured to display the movement direction identifier at a position associated with the character position identifier on the running sub-screen, the movement direction identifier being configured for providing a direction reference to a movement instruction to be initiated by the simulation object in the second time unit, and the movement instruction being configured for instructing to manipulate the virtual character to move.

For a specific embodiment, refer to the examples shown in the foregoing information processing method. Details are not described again in this example.

In an exemplary implementation, a character position identifier of the virtual character is displayed on the thumbnail screen, the execution prediction information includes an operation trajectory identifier, and the apparatus includes
a second display sub-unit, configured to highlight, when a quantity of target candidate operations indicated by the operation trajectory identifier reaches a preset threshold, an operation trajectory identifier associated with the target candidate operation at a position associated with a target character position identifier on the running sub-screen, the operation trajectory identifier being configured for providing a pointing reference to a manipulation instruction to be initiated by the simulation object in the second time unit, the target candidate operation being a same candidate operation of a pointing object, and the target character position identifier being the character position identifier corresponding to the virtual character that is to initiate the target candidate operation in the second time unit.

For a specific embodiment, refer to the examples shown in the foregoing information processing method. Details are not described again in this example.

In an exemplary implementation, the second display unit 2106 includes at least one of the following:
a fifth display module, configured to display execution prediction information corresponding to a to-be-executed pointing operation if the to-be-executed candidate operation is the to-be-executed pointing operation, the execution prediction information corresponding to the to-be-executed pointing operation being configured for providing a pointing reference to a manipulation instruction to be initiated by the simulation object in the second time unit, and the pointing operation being configured for determining a pointing object of the manipulation instruction;
a sixth display module, configured to display execution prediction information corresponding to at least two to-be-executed candidate operations if the to-be-executed candidate operation is the at least two to-be-executed candidate operations, the execution prediction information corresponding to the at least two to-be-executed candidate operations being configured for providing a selection reference to at least two manipulation instructions to be initiated by the simulation object in the second time unit, and manipulation instructions of the at least two manipulation instructions corresponding one-to-one to candidate operations of the at least two to-be-executed candidate operations;
a seventh display module, configured to display execution prediction information corresponding to a to-be-executed movement operation if the to-be-executed candidate operation is the to-be-executed movement operation, the execution prediction information corresponding to the to-be-executed movement operation being configured for providing a direction reference to a movement instruction to be initiated by the simulation object in the second time unit;
an eighth display module, configured to display execution prediction information corresponding to a to-be-executed attack operation if the to-be-executed candidate operation is the to-be-executed attack operation, the execution prediction information corresponding to the to-be-executed attack operation being configured for providing a pointing reference to an attack instruction to be initiated by the simulation object in the second time unit; or
a ninth display module, configured to display execution prediction information corresponding to a to-be-executed configuration operation if the to-be-executed candidate operation is the to-be-executed configuration operation, the execution prediction information corresponding to the to-be-executed configuration operation being configured for providing a pointing reference to a configuration instruction to be initiated by the simulation object in the second time unit, and the configuration operation being configured for determining a pointing item of the configuration instruction.

For a specific embodiment, refer to the examples shown in the foregoing information processing method. Details are not described again in this example.

In an exemplary implementation, the second display unit 2106 includes:
a tenth display module, configured to display execution prediction information corresponding to a first virtual character when a screen perspective of the target virtual game is a character perspective of the first virtual character; and
an eleventh display module, configured to switch the screen perspective of the target virtual game to a character perspective of a second virtual character in response to a switching instruction of the screen perspective of the target virtual game, and displaying execution prediction information corresponding to the second virtual character.

For a specific embodiment, refer to the examples shown in the foregoing information processing method. Details are not described again in this example.

In an exemplary implementation, the apparatus further includes at least one of the following:
a third display unit, configured to display battle basic information of at least one simulation object in a process in which the running screen corresponding to the target virtual game in the first time unit is displayed, the battle basic information being basic information of each of the at least one simulation object;
a fourth display unit, configured to display battle instant information corresponding to the target virtual game in the first time unit in a process in which the running screen corresponding to the target virtual game in the first time unit is displayed, the battle instant information being instant information generated by the target virtual game when the target virtual game is run in the first time unit;
a fifth display unit, configured to display battle historical information corresponding to the target virtual game in the first time unit in a process in which the running screen corresponding to the target virtual game in the first time unit is displayed, the battle historical information being historical information generated by the target virtual game before the target virtual game is run in the first time unit; or
a sixth display unit, configured to display battle prediction information corresponding to the target virtual game in the first time unit in a process in which the running screen corresponding to the target virtual game in the first time unit is displayed, the battle prediction information being prediction information of a battle result of the at least one simulation object participating in the target virtual game.

For a specific embodiment, refer to the examples shown in the foregoing information processing method. Details are not described again in this example.

In an exemplary implementation, the sixth display unit includes:
a first obtaining module, configured to obtain a battle screen of the target virtual game in a running process, the battle screen including the running screen;
a second obtaining module, configured to obtain local battle state information and overall battle state information through the battle screen, the local battle state information being configured for indicating a battle state of each virtual character participating in the target virtual game in the target virtual game, and the overall battle state information being configured for indicating a battle state of the target virtual game in the first time unit;
a first input module, configured to: obtain a first recognition result by using a battle prediction model and based on the local battle state information, and obtain a second recognition result by using the battle prediction model and based on the overall battle state information, the first recognition result being configured for indicating a contribution of each virtual character participating in the target virtual game to the battle result, and the second recognition result being configured for indicating a contribution of the battle state of the target virtual game in the first time unit to the battle result;
a fitting module, configured to fit the first recognition result and the second recognition result, to obtain an evaluation function value, the evaluation function value being configured for evaluating a battle progress of the at least one simulation object in the target virtual game in terms of overall performance and local performance of an object; and
a twelfth display module, configured to obtain and display the battle prediction information based on the evaluation function value.

For a specific embodiment, refer to the examples shown in the foregoing information processing method. Details are not described again in this example.

In an exemplary implementation, the twelfth display module includes:
a determining sub-module, configured to determine, by using the evaluation function value if the target virtual game is a virtual game in which simulation objects of at least two opposing teams participate, prediction remaining duration of each opposing team for which the at least two opposing teams participate in the target virtual game;
an obtaining sub-module, configured to obtain a predicted win rate of each opposing team for the target virtual game based on the predicted remaining duration, the predicted win rate being inversely proportional to the predicted remaining duration; and
a third display sub-module, configured to display the predicted win rate as the battle prediction information.

For a specific embodiment, refer to the examples shown in the foregoing information processing method. Details are not described again in this example.

In an exemplary implementation, the obtaining unit 2104 includes a second input module, configured to obtain an image feature of the running screen based on the running screen and through a first network structure of an image recognition model, the battle reference data including the image feature, the image recognition model being a neural network model trained by using sample data and configured for recognizing an image, and the first network structure being configured to extract the image feature.

The second display unit 2106 includes a third input module, configured to obtain a recognition result based on the image feature of the running screen and through a second network structure of the image recognition model, the execution prediction information including the recognition result.

For a specific embodiment, refer to the examples shown in the foregoing information processing method. Details are not described again in this example.

In an exemplary implementation, the second input module includes:
a recognition sub-module, configured to perform image recognition on the running screen through a convolutional layer in the first network structure, to obtain at least two screen features corresponding to the running screen; and
a concatenation sub-module, configured to perform feature concatenation on the at least two screen features through a full connection layer in the first network structure, to obtain the image feature.

For a specific embodiment, refer to the examples shown in the foregoing information processing method. Details are not described again in this example.

In an exemplary implementation, the concatenation sub-module includes:
a mapping sub-unit, configured to map the image feature to an attention mechanism layer in the second network structure, to obtain a mapping result; and
an input sub-unit, configured to obtain the recognition result through an output layer in the second network structure and based on the mapping result.

For a specific embodiment, refer to the examples shown in the foregoing information processing method. Details are not described again in this example.

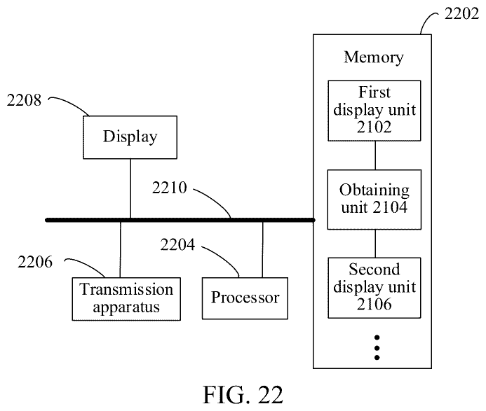

According to still another aspect of the embodiments of this disclosure, an electronic device configured to implement the foregoing information processing method is further provided. As shown in FIG. 22, the electronic device includes a memory 2202 and a processor 2204. The memory 2202 stores a computer program, and the processor 2204 is configured to execute operations in any one of the foregoing method embodiments by using the computer program.

In an exemplary implementation, in this embodiment, the electronic device may be located in at least one network device in a plurality of network devices of a computer network.

In an exemplary implementation, in this embodiment, the foregoing processor may be configured to execute the following operations by using the computer program.
S1: Display a running screen corresponding to a target virtual game in a first time unit, the target virtual game being a virtual game in which at least one simulation object participates, and the simulation object being a virtual object driven by artificial intelligence and configured for simulating and manipulating a virtual character to participate in the target virtual game.
S2: Obtain battle reference data corresponding to the running screen, the battle reference data being battle data fed back by the virtual character when the virtual character participates in the target virtual game in the first time unit.
S3: Display execution prediction information corresponding to a to-be-executed candidate operation based on the battle reference data, the to-be-executed candidate operation being an operation to be executed by the virtual character in a second time unit, the execution prediction information being configured for providing an auxiliary reference related to the battle reference data to a to-be-initiated manipulation instruction, the to-be-initiated manipulation instruction being an instruction to be initiated by the simulation object in the second time unit and configured for manipulating the virtual character to execute the candidate operation, and the second time unit being after the first time unit.

In an exemplary implementation, it is noted that the structure shown in FIG. 22 is merely an example, and the electronic device may also be a terminal device such as a smartphone (such as an Android phone or an iOS phone), a tablet computer, a palmtop computer, a mobile internet device (MID), or a PAD. FIG. 22 does not limit the structure of the foregoing electronic device. For example, the electronic device may further include more or fewer components (such as a network interface) than the components shown in FIG. 22, or have different configuration than the configuration shown in FIG. 22.

In some examples, the memory 2202 may be configured to store a software program and a module, such as program instructions/modules corresponding to the information processing method and apparatus in the embodiments of this disclosure. The processor 2204 executes various functional applications and data processing by running the software program and the module stored in the memory 2202, that is, implements the foregoing information processing method. The memory 2202 can be non-transitory computer-readable storage medium, and may include a high-speed random access memory, and may further include a nonvolatile memory, such as one or more magnetic disk storage apparatus, a flash memory, or another nonvolatile solid-state storage device. In some examples, the memory 2202 may further include a memory remotely disposed relative to the processor 2204, and these remote memories may be connected to the terminal through the network. Examples of the foregoing network include, but are not limited to, an internet, an intranet, a local area network, a mobile communication network, and a combination thereof. The memory 2202 may be, but is not limited to, configured to store information such as a running screen, battle reference data, and execution prediction information. For example, as shown in FIG. 22, the foregoing memory 2202 may include, but is not limited to, the first display unit 2102, the obtaining unit 2104, and the second display unit 2106 in the foregoing information processing apparatus. In addition, other module units of the foregoing information processing apparatus may be further included but are not limited thereto. Details are not described herein again in this example.

In an exemplary implementation, a transmission apparatus 2206 is configured to receive or send data through the network. Specific examples of the foregoing network may include a wired network and a wireless network. In an example, the transmission apparatus 2206 includes a network interface controller (NIC). The network interface controller may be connected to another network device and a router through a network line, to communicate with the internet or the local area network. In an example, the transmission apparatus 2206 is a radio frequency (RF) module, and is configured to communicate with the internet in a wireless manner.

In addition, the foregoing electronic device further includes: a display 2208, configured to display information such as the foregoing running screen, the battle reference data, and the execution prediction information; and a connection bus 2210, configured to connect various module components of the foregoing electronic device.

In another embodiment, the terminal device or the server may be a node in a distributed system. The distributed system may be a blockchain system, and the blockchain system may be a distributed system formed by connecting a plurality of nodes through a form of network communication. A peer to peer (P2P) network may be formed between the nodes. Any form of computing device, for example, an electronic device such as the server or the terminal, may join the peer to peer network to become a node in the blockchain system.

According to an aspect of this disclosure, a computer program product is provided, the computer program product including a computer program, and the computer program including a program code for executing the method shown in the flowchart. In this embodiment, the computer program may be uploaded and installed from the network by using a communication part, and/or be installed from a removable media. When the computer program is executed by a central processing unit, various functions provided in the embodiments of this disclosure are executed.

Sequence numbers of the foregoing embodiments of this disclosure are merely for description, and do not indicate superiority or inferiority of the embodiments.

A computer system of an electronic device is merely an example, and does not limit functions and the scope of usage of the embodiments of this disclosure.

The computer system includes various processing circuitry, such as a central processing unit (CPU), and the central processing unit may perform various appropriate actions and processes based on a program stored in a read-only memory (ROM) or a program loaded to a random access memory (RAM) from a storage part. Various programs and data needed for a system operation are stored in the random access memory. The central processing unit, the read-only memory, and the random access memory are connected to each other through a bus. An input/output interface (I/O interface) is connected to the bus.

The following components are connected to the input/output interface, including an input part of a keyboard, a mouse, and the like; including an input part of a cathode ray tube (CRT), a liquid crystal display (LCD), a speaker, and the like; including a storage part of hardware; and including a communication part of a network interface card such as a local area network card, a modem and the like. The communication part performs communication processing through the network such as the internet. A driver is also connected to the input/output interface as needed. A removable media, such as a magnetic disk, an optical disk, a magneto-optical disk, a semiconductor memory, and the like are installed on the drive as needed, so that it may be read that a computer program is installed to the storage part as needed.

According to some exemplary aspects, based on the embodiments of this disclosure, a process described foregoing with reference to the method flowchart may be implemented as a computer software program. For example, embodiments of this disclosure include a computer program product, and the computer program product is carried on computer program of a computer-readable medium. The computer program includes a program code configured to execute the method shown in the flowchart. In this embodiment, the computer program may be uploaded and installed from the network by using a communication part, and/or be installed from a removable media. When the computer program is executed by the central processing unit, various functions limited in a system of this disclosure are executed.

According to an aspect of this disclosure, a computer-readable storage medium is provided. A processor of a computer device reads the computer program from the computer-readable storage medium, and the processor executes the computer program, so that the computer device executes the method provided in the foregoing implementations.

In an exemplary implementation, in this embodiment, it is noted that all or some of the operations to the embodiments may be by a program instructing relevant hardware of a terminal device. The program may be stored in using a computer-readable storage medium. The storage medium may include a flash disk, a read-only memory (ROM), a random access memory (RAM), magnetic disk, an optical disk, or the like.

Sequence numbers of the foregoing embodiments of this disclosure are merely for description, and do not indicate superiority or inferiority of the embodiments.

When the integrated unit of the foregoing embodiments is implemented in the form of a software functional unit and sold or used as an independent product, the integrated unit may be stored in the foregoing computer-readable storage medium. Based on such an understanding, the technical solutions of this disclosure essentially, or the part contributing to the related art, or all or a part of the technical solutions may be implemented in the form of a software product. The computer software product is stored in a storage medium and includes several instructions for instructing a computer device (which may be a personal computer, a server, or a network device) to perform all or some of the operations in the methods described in the embodiments of this disclosure.

In the foregoing embodiments of this disclosure, the descriptions of each embodiment have different focuses, and for a part that is not described in detail in an embodiment, refer to the relevant description of other embodiments.

In several embodiments provided in this disclosure, a disclosed client may be implemented in other manners. For example, the described apparatus embodiment is merely an example. For example, the unit division is merely logical function division and may be other division during actual implementation. For example, a plurality of units or components may be combined or integrated into another system, or some features may be ignored or not performed. In addition, the displayed or discussed mutual couplings or direct couplings or communication connections may be implemented by some interfaces; indirect couplings or communication connections between units or modules which may be electric or in other forms.

The units described as separate parts may or may not be physically separate, and parts displayed as units may or may not be physical units, and may be located at one position, or may be distributed on a plurality of network units. Some or all of the units may be selected according to actual requirements to achieve the objectives of the solutions of the embodiments.

In addition, function units in embodiments of this disclosure may be integrated into one processing unit, or each of the units may exist alone physically, or two or more units may be integrated into one unit. The integrated unit may be implemented in a form of hardware, or may be implemented in a form of a software function unit.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing is merely some exemplary implementations of the embodiments of this disclosure. it is noted that several improvements and refinements can be made without departing from the principle of this disclosure, and the improvements and refinements a shall fall within the protection scope of this disclosure.

What is claimed is:

1. A method of information processing, comprising:
displaying a running screen of a target virtual game in a first time unit, the target virtual game including at least a first virtual character that is manipulated by an artificial intelligence (AI) object,;
obtaining battle reference data associated with the running screen, the battle reference data being battle data fed back by the first virtual character when the first virtual character participates in the target virtual game in the first time unit; and
displaying execution prediction information of at least a to-be-executed candidate operation based on the battle reference data, the to-be-executed candidate operation being a candidate operation to be executed by the first virtual character in a second time unit after the first time unit, the execution prediction information including an auxiliary reference related to the battle reference data for a to-be-initiated manipulation instruction that is to be initiated by the AI object in the second time unit to cause the first virtual character to execute the to-be-executed candidate operation.

2. The method according to claim 1, wherein the displaying the execution prediction information comprises:
displaying first probability distribution information of at least a first to-be-executed candidate operation and a second to-be-executed candidate operation, the first probability distribution information indicating at least a first probability that the first virtual character executes the first to-be-executed candidate operation in the second time unit and a second probability that the first virtual character executes the second to-be-executed candidate operation in the second time unit.

3. The method according to claim 1, wherein the displaying the execution prediction information comprises:
displaying second probability distribution information of the first virtual character executing the to-be-executed candidate operation on at least a first pointing object and a second pointing object, the second probability distribution information indicating at least a first probability that the first virtual character executes the to-be-executed candidate operation on the first pointing object in the second time unit, and a second probability that the first virtual character executes the to-be-executed candidate operation on the second pointing object in the second time unit.

4. The method according to claim 1, wherein:
the displaying the running screen comprises:
displaying the running screen in a first interface area in a battle viewing interface; and
the displaying the execution prediction information comprises:
displaying the execution prediction information in a second interface area in the battle viewing interface.

5. The method according to claim 4, wherein the running screen comprises a running main screen and a running sub-screen, the running main screen is a real-time screen of a virtual scene in the target virtual game, the running sub-screen is a thumbnail screen of the virtual scene, the method further comprises:
displaying, in a first sub-area in the first interface area, the running main screen of the target virtual game in the first time unit;
displaying, in a second sub-area in the first interface area, the running sub-screen of the target virtual game in the first time unit; and
displaying the execution prediction information on the running sub-screen, and in a third sub-area in the second interface area.

6. The method according to claim 5, wherein a character position identifier of the first virtual character is displayed on the thumbnail screen, the execution prediction information comprises a movement direction identifier, and the displaying the execution prediction information comprises:
displaying the movement direction identifier at a position associated with the character position identifier on the running sub-screen, the movement direction identifier indicating a direction reference to a movement instruction expected to be initiated by the AI object in the second time unit to cause the first virtual character to move.

7. The method according to claim 5, wherein a character position identifier of the first virtual character is displayed on the thumbnail screen, and the displaying the execution prediction information comprises:
highlighting, when a number of target candidate operations associated with a first pointing object reaches a preset threshold, an operation trajectory identifier at a position associated with a target character position identifier of the first virtual character on the running sub-screen, the operation trajectory identifier providing a pointing reference to a manipulation instruction expected to be initiated by the AI object in the second time unit,.

8. The method according to claim 1, wherein the displaying the execution prediction information comprises at least one of:
displaying execution prediction information of a to-be-executed pointing operation, the execution prediction information of the to-be-executed pointing operation providing a pointing reference to a manipulation instruction expected to be initiated by the AI object in the second time unit for determining a pointing object of the manipulation instruction;
displaying execution prediction information of two or more to-be-executed candidate operations, the execution prediction information of the two or more to-be-executed candidate operations providing a selection reference to two or more manipulation instructions expected to be initiated by the AI object in the second time unit, and the two or more manipulation instructions respectively corresponding to the two or more to-be-executed candidate operations;
displaying execution prediction information of a to-be-executed movement operation, the execution prediction information of the to-be-executed movement operation providing a direction reference to a movement instruction to be initiated by the AI object in the second time unit;
displaying execution prediction information of a to-be-executed attack operation, the execution prediction information of the to-be-executed attack operation providing a pointing reference to an attack instruction to be initiated by the AI object in the second time unit; or
displaying execution prediction information of a to-be-executed configuration operation, the execution prediction information of the to-be-executed configuration operation providing a pointing reference to a configuration instruction expected to be initiated by the AI object in the second time unit, and the to-be-executed configuration operation determining a pointing item of the configuration instruction.

9. The method according to claim 1, wherein the displaying the execution prediction information comprises:
displaying the execution prediction information associated with the first virtual character when a screen perspective of the target virtual game is of the first virtual character;
switching the screen perspective of the target virtual game to a second virtual character in response to a switching instruction of the screen perspective of the target virtual game; and
displaying execution prediction information associated with the second virtual character.

10. The method according to claim 1, further comprising at least one of:
displaying battle basic information of one or more AI objects, the battle basic information being basic information of each of the one or more AI objects;
displaying battle instant information of the target virtual game in the first time unit, the battle instant information being instant information generated by the target virtual game when the target virtual game is run in the first time unit;
displaying battle historical information of the target virtual game in the first time unit, the battle historical information being historical information generated by the target virtual game before the first time unit; or
displaying battle prediction information of the target virtual game in the first time unit, the battle prediction information being prediction information of a battle result of the one or more AI objects in the target virtual game.

11. The method according to claim 1, further comprising:
obtaining a battle screen of the target virtual game during a running process of the target virtual game, the battle screen comprising the running screen;
obtaining local battle state information and overall battle state information according to the battle screen, the local battle state information including respective battle state of a plurality of virtual characters in the target virtual game, and the overall battle state information including a time unit based battle state of the first time unit in the target virtual game;
obtaining a first recognition result based on a battle prediction model the local battle state information, the first recognition result indicating contributions of the plurality of virtual characters respectively to a battle result;
obtaining a second recognition result based on the battle prediction model and the overall battle state information, the second recognition result indicating a contribution of the time unit based battle state of the first time unit to the battle result;
fitting according to the first recognition result and the second recognition result, to obtain an evaluation function value, the evaluation function value indicating a battle progress of at least the AI object in the target virtual game;
obtaining battle prediction information based on the evaluation function value of the target virtual game in the first time unit, the battle prediction information being prediction information of the battle result of at least the AI object in the target virtual game; and
displaying the battle prediction information of the target virtual game in the first time unit.

12. The method according to claim 11, wherein the obtaining the battle prediction information based on the evaluation function value comprises:
determining, by using the evaluation function value when the target virtual game includes AI objects in two or more opposing teams, predicted remaining durations respectively for the two or more opposing teams in the target virtual game;
obtaining predicted win rates respectively of the two or more opposing teams for the target virtual game based on the predicted remaining durations, a predicted win rate in the predicted win rates being inversely proportional to a predicted remaining duration in the predicted remaining duration; and
displaying the predicted win rates as the battle prediction information.

13. The method according to claim 1, wherein:
the obtaining the battle reference data comprises:
obtaining an image feature of the running screen based on the running screen and according to a first network structure of an image recognition model, the battle reference data comprising the image feature, and the image recognition model being a neural network model; and
the displaying the execution prediction information comprises:
obtaining a recognition result based on the image feature of the running screen and according to a second network structure of the image recognition model, the execution prediction information comprising the recognition result.

14. The method according to claim 13, wherein the obtaining the image feature comprises:
performing image recognition on the running screen using a convolutional layer in the first network structure, to obtain at least two screen features of the running screen; and
performing feature concatenation on the at least two screen features using a full connection layer in the first network structure, to obtain the image feature.

15. The method according to claim 13, wherein the obtaining the recognition result comprises:
mapping the image feature to an attention mechanism layer in the second network structure, to obtain a mapping result; and
obtaining the recognition result using an output layer in the second network structure and based on the mapping result.

16. An apparatus, comprising processing circuitry configured to:
display a running screen of a target virtual game in a first time unit, the target virtual game including at least a first virtual character that is manipulated by an artificial intelligence (AI) object;
obtain battle reference data associated with the running screen, the battle reference data being battle data fed back by the first virtual character when the first virtual character participates in the target virtual game in the first time unit; and
display execution prediction information of at least a to-be-executed candidate operation based on the battle reference data, the to-be-executed candidate operation being a candidate operation to be executed by the first virtual character in a second time unit after the first time unit, the execution prediction information including an auxiliary reference related to the battle reference data for a to-be-initiated manipulation instruction that is to be initiated by the AI object in the second time unit to cause the first virtual character to execute the to-be-executed candidate operation.

17. The apparatus according to claim 16, wherein the processing circuitry is configured to:
display first probability distribution information of at least a first to-be-executed candidate operation and a second to-be-executed candidate operation, the first probability distribution information indicating at least a first probability that the first virtual character executes the first to-be-executed candidate operation in the second time unit and a second probability that the first virtual character executes the second to-be-executed candidate operation in the second time unit.

18. The apparatus according to claim 16, wherein the processing circuitry is configured to:
display second probability distribution information of the first virtual character executing the to-be-executed candidate operation on at least a first pointing object and a second pointing object, the second probability distribution information indicating at least a first probability that the first virtual character executes the to-be-executed candidate operation on the first pointing object in the second time unit, and a second probability that the first virtual character executes the to-be-executed candidate operation on the second pointing object in the second time unit.

19. The apparatus according to claim 16, wherein the processing circuitry is configured to:
display the running screen in a first interface area in a battle viewing interface; and
display the execution prediction information in a second interface area in the battle viewing interface.

20. A non-transitory computer-readable storage medium storing instructions which when executed by at least one processor cause the at least one processor to perform:
displaying a running screen of a target virtual game in a first time unit, the target virtual game including at least a first virtual character that is manipulated by an artificial intelligence (AI) object;
obtaining battle reference data associated with the running screen, the battle reference data being battle data fed back by the first virtual character when the first virtual character participates in the target virtual game in the first time unit; and
displaying execution prediction information of at least a to-be-executed candidate operation based on the battle reference data, the to-be-executed candidate operation being a candidate operation to be executed by the first virtual character in a second time unit after the first time unit, the execution prediction information including an auxiliary reference related to the battle reference data for a to-be-initiated manipulation instruction that is to be initiated by the AI object in the second time unit to cause the first virtual character to execute the to-be-executed candidate operation.
